(19) United States
(12) Patent Application Publication
(10) Pub. No.: US 2025/0116881 A1
(43) Pub. Date: Apr. 10, 2025

(54) Optical Device and Manufacturing Method Thereof, Display Assembly, and Head-up Display System

(71) Applicant: BOE TECHNOLOGY GROUP CO., LTD., Chaoyang District, Beijing (CN)

(72) Inventors: Xintong Zhu, Beijing (CN); Zhihong Du, Beijing (CN); Wenbo LI, Beijing (CN); Jindou Liu, Beijing (CN); Hanbing Zhang, Beijing (CN)

(21) Appl. No.: 18/687,164

(22) PCT Filed: Feb. 15, 2023
(86) PCT No.: PCT/CN2023/076266

§ 371 Date: Feb. 27, 2024

(51) Int. Cl. G02B 30/56; G02B 1/02; G02B 5/09; G02B 27/01

(52) U.S. Cl. CPC G02B 30/56; G02B 1/02; G02B 5/09; G02B 27/0101; G02B 2027/013

(57) ABSTRACT

An optical device is disclosed. The optical device includes a plurality of reflective pillars extending in a first direction, and the plurality of reflective pillars are arranged in a plurality of rows and a plurality of columns. The first direction is perpendicular to both a row direction and a column direction. Every at least three adjacent reflective pillars define an optical channel extending in the first direction. Each optical channel includes a plurality of reflective surfaces arranged in a circumferential direction of the optical channel, and the plurality of reflective surfaces include two reflective surfaces that are adjacent and perpendicular to each other. A plurality of reflective surfaces defining the optical channel are respectively located on different reflective pillars.

### CROSS-REFERENCE TO RELATED APPLICATION

This application is the United States national phase of International Patent Application No. PCT/CN2023/076266, filed Feb. 15, 2023, the disclosure of which is hereby incorporated by reference in its entirety.

### BACKGROUND OF THE INVENTION

### Field of the Invention

The present disclosure relates to the field of display technologies, and in particular, to an optical device and a manufacturing method thereof, a display assembly, and a head-up display system.

### Description of Related Art

With the development of science and technology, air imaging technology has become more and more mature, so that the air imaging technology is widely used in many fields. For example, the air imaging technology may be widely used in the in-vehicle field.

The most common air imaging technology at present may use a reflector to reflect multiple rays of light provided by the light source, so that the multiple rays of rays provided by the light source may be reflected and change the light path to converge in the air to form a projected real image that is consistent with the display image provided by the light source.

### SUMMARY OF THE INVENTION

In an aspect, an optical device is provided. The optical device includes a plurality of reflective pillars extending in a first direction, and the plurality of reflective pillars are arranged in a plurality of rows and a plurality of columns. The first direction is perpendicular to both a row direction and a column direction. Every at least three adjacent reflective pillars define an optical channel extending in the first direction. Each optical channel includes a plurality of reflective surfaces arranged in a circumferential direction of the optical channel, and the plurality of reflective surfaces include two reflective surfaces that are adjacent and perpendicular to each other. A plurality of reflective surfaces defining the optical channel are respectively located on different reflective pillars.

In some embodiments, in the reflective pillars defining the optical channel, side edges of every two adjacent reflective pillars are connected to each other to define the optical channel.

In some embodiments, the optical channel is defined by 4 adjacent reflective pillars, the optical channel includes 4 reflective surfaces arranged in the circumferential direction of the optical channel, and an included angle between planes where every two adjacent reflective surfaces are located is a right angle.

In some embodiments, widths of the reflective surfaces defining the optical channel are equal.

In some embodiments, a reflective pillar in the plurality of reflective pillars is in a shape of a regular quadrangular prism.

In some embodiments, a depth-to-width ratio of a reflective pillar in the plurality of reflective pillars is in a range of 1:1 to 3:1, inclusive.

In some embodiments, a depth of a reflective pillar in the plurality of reflective pillars in the first direction is in a range of 100 μm to 600 μm, inclusive.

In some embodiments, the depth of the reflective pillar in the first direction is approximately 150 μm, and a depth-to-width ratio of the reflective pillar is approximately 2.67.

In some embodiments, the optical device includes a plurality of optical channels; spatial uniformity of multiple rays of light reflected by the plurality of optical channels is in a range of 100 to 250, inclusive.

In some embodiments, a surface roughness of a reflective surface is less than or equal to 0.8 μm.

In some embodiments, a material of a reflective pillar in the plurality of reflective pillars includes any one of silver, aluminum and nickel.

In some embodiments, the optical device further includes a transparent support layer. The transparent support layer includes a plurality of transparent support portions, a transparent support portion is located between adjacent reflective pillars, and fills an optical channel.

In some embodiments, a material of the transparent support layer includes any one of resin, glass cement, and polymethyl methacrylate.

In some embodiments, a reflective pillar in the plurality of reflective pillars includes a first surface and a second surface that are arranged oppositely in the first direction. The optical device further includes a transparent protective layer; the transparent protective layer includes a first transparent protective layer located on a side of first surfaces of the plurality of reflective pillars away from second surfaces of the plurality of reflective pillars; and/or the transparent protective layer includes a second transparent protective layer located on a side of the second surfaces of the plurality of reflective pillars away from the first surfaces of the plurality of reflective pillars.

In some embodiments, the optical device further includes a transparent support layer, the transparent support layer includes a plurality of transparent support portions, and a transparent support portion is located between adjacent reflective pillars and fills an optical channel; a refractive index of the transparent protective layer is substantially equal to a refractive index of the transparent support layer.

In some embodiments, a material of the transparent protective layer includes inorganic glass or organic glass.

In an aspect, a display assembly is provided. The display assembly includes a display apparatus and the optical device as described in the embodiments described above. A first included angle is formed between the display apparatus and the optical device, and the first included angle is in a range of 30° to 60°, inclusive.

In yet another aspect, a head-up display system is provided. The head-up display system includes the display assembly provided by the above embodiments.

In yet another aspect, a manufacturing method of an optical device is provided. The optical device includes a plurality of reflective pillars extending in a first direction, and the plurality of reflective pillars are arranged in a plurality of rows and a plurality of columns; wherein the first direction is perpendicular to both a row direction and a column direction. Every at least three adjacent reflective pillars define an optical channel extending in the first direction; each optical channel includes a plurality of reflective surfaces arranged in a circumferential direction of the optical channel, and the plurality of reflective surfaces include two reflective surfaces that are adjacent and perpendicular to each other; a plurality of reflective surfaces defining the optical channel are respectively located on different reflective pillars.

The manufacturing method of the optical device includes: providing a substrate; and forming the plurality of reflective pillars on the base substrate to form the optical device.

In some embodiments, the base substrate includes a transparent base substrate; performing a burning process on the transparent base substrate to form a plurality of first hollow regions and a plurality of transparent support blocks, every adjacent at least three first hollow regions being arranged around a transparent support block; forming a seed layer on a side of the transparent base substrate; injecting a metal into the plurality of first hollow regions by electroforming to form the plurality of reflective pillars, every at least three adjacent reflective pillars being arranged around a transparent support block; and removing the seed layer.

In some embodiments, the base substrate includes a metal base substrate or a silicon-based base substrate; forming the plurality of reflective pillars on the base substrate includes: patterning the base substrate to form a plurality of first support portions, every at least three adjacent first support portions defining a second hollow region; performing copy and demolding on the base substrate by press molding to form a base model having a plurality of third hollow regions and a plurality of second support portions that are transparent; every at least three adjacent third hollow regions being arranged around a second support portion; forming a seed layer on a side of the base model; injecting a metal into the plurality of third hollow regions by electroforming to form the plurality of reflective pillars; every at least three adjacent reflective pillars being arranged around a second support portion; and removing the seed layer.

In some embodiments, the base substrate includes a glass base substrate; forming the plurality of reflective pillars on the base substrate includes: forming a seed layer on the glass base substrate; patterning the seed layer to form a plurality of base portions, every at least three adjacent bases defining an opening region; forming an organic photosensitive material layer that is transparent on a side of the seed layer away from the glass base substrate; performing exposure and development on the organic photosensitive material layer by using a mask, so that the organic photosensitive material layer forms a plurality of via holes and a plurality of organic photosensitive material portions, and the via holes expose the base portions; and injecting a metal into the via holes by electroforming to form the reflective pillars on the base portions, so as to form the optical device; every at least three adjacent reflective pillars being arranged around an organic photosensitive material portion.

### BRIEF DESCRIPTION OF THE DRAWINGS

In order to describe technical solutions in the present disclosure more clearly, the accompanying drawings to be used in some embodiments of the present disclosure will be introduced briefly. Obviously, the accompanying drawings to be described below are merely drawings of some embodiments of the present disclosure, and a person of ordinary skill in the art can obtain other drawings according to those drawings. In addition, the accompanying drawings in the following description may be regarded as schematic diagrams, but are not limitations on actual sizes of products, actual processes of methods and actual timings of signals involved in the embodiments of the present disclosure.

FIG. 1 is a structural diagram of a display assembly, in accordance with some embodiments;

FIG. 2 is a structural diagram of another display assembly, in accordance with some embodiments;

FIG. 3 is a structural diagram of a head-up display system, in accordance with some embodiments;

FIG. 4 is a structural diagram of a seat display system, in accordance with some embodiments;

FIG. 5 is a structural diagram of an optical device, in accordance with some implementations;

FIG. 6 is an optical path diagram of the optical device in FIG. 5;

FIG. 7 is a structural diagram of an optical device, in accordance with some embodiments;

FIG. 8 is a top view of an optical device, in accordance with some embodiments;

FIG. 9 is an enlarged partial view of the Q region in FIG. 7;

FIG. 10 is a structural diagram of an optical channel in FIG. 9;

FIG. 11 is a top view of an optical channel in FIG. 9;

FIG. 12 is a top view of another optical device, in accordance with some embodiments;

FIG. 13 is a broken line graph of spatial uniformity of a real image projected by an optical device, in accordance with some embodiments;

FIG. 14 is a broken line graph of a spot radius of a real image projected by an optical device, in accordance with some embodiments;

FIG. 15 is a broken line graph of a total luminous flux of a real image projected by an optical device, in accordance with some embodiments;

FIG. 16 is a structural diagram of yet another optical device, in accordance with some embodiments;

FIG. 17 is a top view of another optical device, in accordance with some embodiments;

FIG. 18 is a section of an optical device, in accordance with some embodiments;

FIG. 19 is a flow diagram of a manufacturing method of an optical device, in accordance with some embodiments;

FIG. 20 is a flow diagram of some steps in FIG. 19;

FIG. 21 is a structural diagram of some steps in FIG. 20;

FIG. 22 is another flow diagram of some steps in FIG. 19;

FIG. 23 is a structural diagram of some steps in FIG. 22;

FIG. 24 is yet another flow diagram of some steps in FIG. 19; and

FIG. 25 is a structural diagram of some steps in FIG. 24.

### DESCRIPTION OF THE INVENTION

The technical solutions in embodiments of the present disclosure will be described clearly and completely with reference to the accompanying drawings. Obviously, the described embodiments are merely some but not all of embodiments of the present disclosure. All other embodiments obtained on the basis of the embodiments of the present disclosure by a person of ordinary skill in the art shall be included in the protection scope of the present disclosure.

Unless the context requires otherwise, throughout the description and claims, the term “comprise” and other forms thereof such as the third-person singular form “comprises” and the present participle form “comprising” are construed as an open and inclusive meaning, i.e., “included, but not limited to”. In the description of the specification, terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, specific features, structures, materials, or characteristics described herein may be included in any one or more embodiments or examples in any suitable manner.

Hereinafter, the terms such as “first” and “second” are used for descriptive purposes only, but are not to be construed as indicating or implying the relative importance or implicitly indicating the number of indicated technical features. Thus, a feature defined with “first” or “second” may explicitly or implicitly include one or more of the features. In the description of the embodiments of the present disclosure, the term “a plurality of” or “the plurality of” means two or more unless otherwise specified.

In the description of some embodiments, “connected” and its derivative expressions may be used. The term “connected” or “connection” shall be understood in a broad sense. For example, “connected” or “connection” may be a fixed connection, a detachable connection, or an integrated connection; it may be directly connected or indirectly connected through an intermediate medium.

The phrase “at least one of A, B and C” has the same meaning as the phrase “at least one of A, B or C”, and they both include following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

As used herein, the term “if” is, optionally, construed to mean “when” or “upon” or “in response to determining” or “in response to detecting”, depending on the context. Similarly, depending on the context, the phrase “if it is determined” or “if [a stated condition or event] is detected” is optionally construed as “in a case where it is determined”, “in response to determining”, “in a case where [the stated condition or event] is detected”, or “in response to detecting [the stated condition or event]”.

In addition, the use of the phrase “based on” is meant to be open and inclusive, since a process, step, calculation or other action that is “based on” one or more of the stated conditions or values may, in practice, be based on additional conditions or values beyond those stated.

The term such as “about”, “substantially” or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

The term such as “parallel”, “perpendicular” or “equal” as used herein includes a stated case and a case similar to the stated case within an acceptable range of deviation determined by a person of ordinary skill in the art, considering measurement in question and errors associated with measurement of a particular quantity (i.e., limitations of a measurement system). For example, the term “parallel” includes absolute parallelism and approximate parallelism, and an acceptable range of deviation of the approximate parallelism may be, for example, a deviation within 5°; the term “perpendicular” includes absolute perpendicularity and approximate perpendicularity, and an acceptable range of deviation of the approximate perpendicularity may also be, for example, a deviation within 5°; and the term “equal” includes absolute equality and approximate equality, and an acceptable range of deviation of the approximate equality may be, for example, that a difference between two equals is less than or equal to 5% of either of the two equals.

It will be understood that, when a layer or element is referred to as being on another layer or substrate, it may be that the layer or element is directly on the another layer or substrate, or it may be that intervening layer(s) exist between the layer or element and the another layer or substrate.

Exemplary embodiments are described herein with reference to sectional views and/or plan views as idealized exemplary drawings. In the accompanying drawings, thicknesses of layers and sizes of regions (areas) are enlarged for clarity. Variations in shape relative to the accompanying drawings due to, for example, manufacturing technologies and/or tolerances may be envisaged. Therefore, the exemplary embodiments should not be construed as being limited to the shapes of the regions shown herein, but including deviations due to, for example, manufacturing. For example, an etched region shown in a rectangular shape generally has a feature of being curved. Therefore, the regions shown in the accompanying drawings are schematic in nature, and their shapes are not intended to show actual shapes of the regions in an apparatus, and are not intended to limit the scope of the exemplary embodiments.

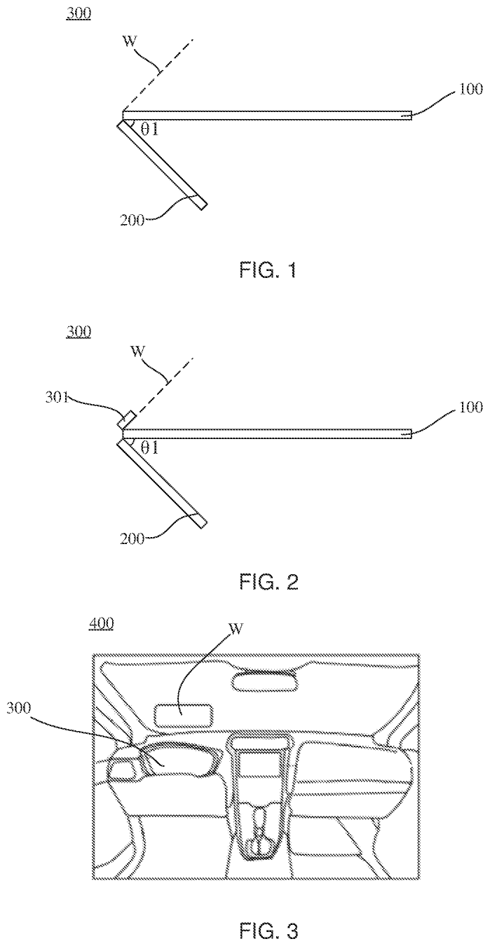

FIG. 1 is a structural diagram of a display assembly, in accordance with some embodiments. Referring to FIG. 1, some embodiments of the present disclosure provide a display assembly 300. The display assembly 300 includes an optical device 100 and a display apparatus 200.

The display apparatus 200 may be an electroluminescent display apparatus or a photoluminescent display apparatus. In a case where the display apparatus is the electroluminescent display apparatus, the electroluminescent display apparatus may be an organic light-emitting diode (OLED) display apparatus or a quantum dot light-emitting diode (QLED) display apparatus. In a case where the display apparatus is the photoluminescent display apparatus, the photoluminescent display apparatus may be a quantum dot photoluminescent display apparatus.

For example, the display apparatus 200 may be any display apparatus that can display images whether in motion (e.g., videos) or stationary (e.g., static images), and whether textual or graphical. More specifically, it is expected that the display apparatus in the embodiments may be implemented in or associated with a plurality of electronic devices. The plurality of electronic devices may include (but is not limit to), for example, mobile telephones, wireless devices, personal data assistants (PDA), hand-held or portable computers, GPS receivers/navigators, cameras, MP4 video players, video cameras, game consoles, watches, clocks, calculators, TV monitors, flat panel displays, computer monitors, car displays (e.g., odometer displays), navigators, cockpit controllers and/or displays, camera view displays (e.g., rear view camera displays in vehicles), electronic photos, electronic billboards or indicators, projectors, building structures, packagings and aesthetic structures (e.g., a display for an image of a piece of jewelry).

The display apparatus 200 and the optical device 100 are arranged to intersect, so that a first included angle θ1 is formed between the display apparatus 200 and the optical device 100.

When displaying an image, the display apparatus 200 may emit multiple rays of light. Since the display apparatus 200 and the optical device 100 are arranged to intersect to each other, multiple rays of light emitted by the display apparatus 200 may be incident into the optical device 100, undergo multiple reflections in the optical device 100, and then exit from the optical device 100. After being reflected out of the optical device 100, multiple rays of light may converge in the air to form a real image W (a real mirror image). That is, the optical device 100 may be used to project a display image formed by the display apparatus 200 onto the air on the other side of the display apparatus 200 to form a real image W (a real mirror image) that is the same as the display image.

A first included angle θ1 is provided between the display apparatus 200 and the optical device 100. That is, the incident angle of the light emitted by the display apparatus 200 to the optical device 100 may be the first included angle θ1. Based on this, it may be satisfied that after being reflected at least twice in the optical device 100, the light is emitted and then converges in a fixed area to form a real image W (a real mirror image) that is the same as the display image. That is, it may be possible to prevent the emitted light from being incident into a space outside the fixed area and forming stray light. Furthermore, the incident angle of the light emitted by the display apparatus 200 to the optical device 100 may be set to be the first included angle θ1, which may help reduce the impact of the stray light on the formation of the real image W (real mirror image) and improve the clarity and brightness of the real image W (real mirror image).

In some examples, the first included angle θ1 may be in a range of 30° to 60°, inclusive.

In a case where the first included angle θ1 is equal to or approaches 30° or 60°, it may be satisfied that the light is reflected at least twice in the optical device 100 and then emitted, and converges in a fixed area to form the real image W (real mirror image) that is the same as the display image. Furthermore, the real image W (real mirror image) and the display apparatus 200 may be made axially symmetrical with respect to the optical device 100, so that the position of the real image W (real mirror image) may be adjusted well.

In a case where the first included angle θ1 is equal to or approaches an intermediate value of 30° and 60°, i.e., in a case where the first included angle θ1 is equal to or approaches 45°, it may be satisfied that the light is reflected at least twice in the optical device 100 and then emitted, and converges well in a fixed area in the air to form the real image W (real mirror image) that is the same as the display image.

In some examples, the first included angle θ1 is approximately 45°. In a case where the incident angle of the light emitted by the display apparatus 200 to the optical device 100 is adjusted to 45°, the angle of the light emitted from the optical device 100 may be adjusted to make the light well converge in a fixed area in the air to form the real image W (real mirror image) that is the same as the display image, which is beneficial to improving the imaging effect.

In some embodiments, the light provided by the display apparatus 200 may be collimated light.

In some embodiments, the display assembly 300 further includes a frame. The frame may include a first mounting bracket and a second mounting bracket. The first mounting bracket and the second mounting bracket intersect, and the first mounting bracket and the second mounting bracket intersect to form a second included angle. The second included angle is equal to the first included angle.

The optical device 100 is installed in the first mounting bracket, and the display apparatus 200 is installed in the second mounting bracket, so that the first included angle θ1 is formed between the display apparatus 200 and the optical device 100.

However, some embodiments of the present disclosure are not limited to this. The display apparatus 200 and the optical device 100 may also be fixed using other structures to satisfy the first included angle θ1 formed between the display apparatus 200 and the optical device 100.

FIG. 2 is a structural diagram of another display assembly, in accordance with some embodiments,

In some embodiments, referring to FIG. 2, the display assembly 300 further includes a gesture acquisition device 301. The gesture acquisition device 301 is disposed on a side of the optical device 100 away from the display apparatus 200. For example, the gesture acquisition device 301 is located on a same plane as the real image W (real mirror image) in the air.

With such arrangement, it is possible to help quickly acquire a hand position and facilitate the gesture operations of the user.

For example, there is a second included angle between the gesture acquisition device 301 and the display apparatus 200, and the second included angle is substantially equal to the first included angle formed between the display apparatus 200 and the optical device 100.

In some other examples, the display assembly 300 may further include a suspension tactile feedback device. The display assembly 300 may use the suspension tactile feedback device to reproduce the touch sensation for the user through a series of actions such as force and vibration, so as to provide tactile feedback to the hands of the user. For example, the suspended tactile feedback device may be an ultrasonic array suspension tactile feedback device, and the embodiments of the present disclosure are not limited thereto.

In some other examples, the display assembly 300 may be provided with a voice interaction function therein. The display apparatus 200 may be used to form a voice sprite. When the user wakes up the voice sprite, the voice sprite formed by the display apparatus 200 may be projected on the air through the optical device 100 to form a suspended voice sprite, and provide interactive services to the user by receiving voice commands.

The following will be described by taking an example in which the display assembly 300 is used in a vehicle-mounted scenario.

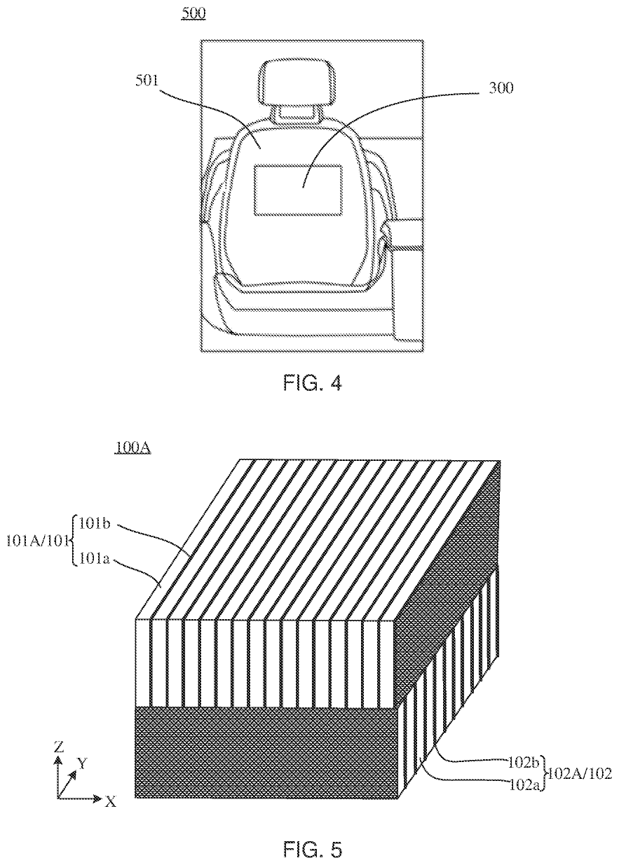

FIG. 3 is a structural diagram of a head-up display system, in accordance with some embodiments.

Some embodiments of the present disclosure provide a head-up display system 400. As shown in FIG. 3, the display assembly 300 may be applied to a center console of a vehicle to form the head-up display system 400 using the display assembly 300.

The display apparatus 200 in the display assembly 300 is closer to the inside of the center console than the optical device 100. That is, the optical device 100 may be used to hide the display apparatus 200 in the center console. In other words, the optical device 100 in the display assembly 300 is closer to the user's side than the display apparatus 200.

Based on this, the light emitted by the display apparatus 200 may be projected onto the air in the vehicle on the side of the optical device 100 away from the display apparatus 200 after passing through the optical device 100. That is, after being reflected by the optical device 100, the light emitted by the display apparatus 200 may be projected to the side of the optical device 100 proximate to the user, so that the user may view the real image W (real mirror image) corresponding to the display image of the display apparatus 200 formed by the optical device 100, so as to form a head-up display system (HUD).

For example, the display assembly 300 uses the optical device 100 to project the display image formed by the display apparatus 200 onto the front windshield. In this case, the display apparatus 200 in the display assembly 300 may be an instrument panel.

However, some embodiments of the present disclosure are not limited to this type of display apparatus 200. For example, the display apparatus 200 may also be a central control screen of a vehicle.

FIG. 4 is a structural diagram of a seat display system, in accordance with some embodiments.

Some embodiments of the present disclosure provide a seat display system 500. As shown in FIG. 4, the display assembly 300 may be applied in the rear seat 501 of the vehicle to form a seat display system 500 using the display assembly 300.

In some examples, the display assembly 300 may be located on a side of the driver's seat away from the front windshield. It will be understood that in some other examples, the display assembly 300 may be located on a side of the passenger seat away from the front windshield.

The display apparatus 200 in the display assembly 300 is closer to the inside of the rear seat 501 than the optical device 100. That is, the optical device 100 may be used to hide the display apparatus 200 in the rear seat 501. In other words, the optical device 100 in the display assembly 300 is closer to the user's side than the display apparatus 200.

Based on this, the optical device 100 is used to project the image formed by the display apparatus 200 onto the side of the driver's seat away from the windshield, creating the effect of an in-vehicle entertainment screen in the rear row.

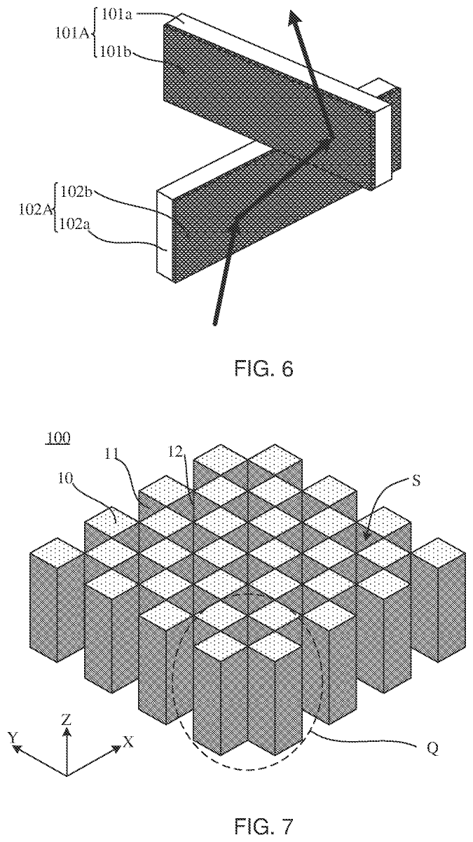

FIG. 5 is a structural diagram of an optical device, in accordance with some implementations. FIG. 6 is an optical path diagram of the optical device in FIG. 5.

In some implementations, as shown in FIGS. 5 and 6, the optical device 100A is of a double-layer structure. The optical device includes a first optical film layer 101 and a second optical film layer 102 arranged in a direction Z.

The first optical film layer 101 includes a plurality of first optical structures 101A arranged in a direction X. The first optical structure 101A includes a first light-transmitting component 101a, and a first reflective layer 101b attached to the first light-transmitting component 101a.

The second optical film layer 102 includes a plurality of second optical structures 102A arranged in the direction Y. The second optical structure 102A includes a second light-transmitting component 102a, and a second reflective layer 102b attached to the second light-transmitting component 102a.

As described above, the optical device 100A is of a double-layer structure, and the arrangement direction of the first optical structures 101A is perpendicular to the arrangement direction of the second optical structures 102A. The plurality of light rays provided by the light source may pass through the second light-transmitting component 102a to be incident on the second reflective layer 102b, the reflected light formed by reflection by the second reflective layer 102b may pass through the first optical structure 101A to be incident on the first reflective layer 101b, and the reflected light formed by the first reflective layer 101b may exit from the optical device 100A. Multiple rays of light reflected by the optical device 100A may converge in the air on the side of the optical device 100A away from the light source to form a real image (real mirror image).

That is to say, the optical device 100A may use the first optical structure 101A and the second optical structure 102A that cooperate with each other to make the light incident on the optical device 100A may be emitted after secondary reflection and may converge in the air on the side of the optical device 100A away from the light source to form a real image (real mirror image).

When the optical device 100A is formed, a reflective layer needs to be coated on the optical structure master. The master with the reflective layer is then cut to form the plurality of first optical structures 101A. The plurality of first optical structures 101A are bonded together to form a first layer of the optical device 100A. The second optical structure 102A is formed in the same manner as the first optical structure 101A described above. As for the above-mentioned manufacturing method, the first optical structures 101A and the second optical structures 102A formed by cutting are each in a shape of a long strip, and is difficult to cut, and the problems such as bubbles, deformation, and unevenness may easily occur during bonding, resulting in high production difficulty for optical device 100A, which is not conducive to mass production.

Alternatively, when the optical device 100A is formed, photolithography may be used. However, due to the small thickness of the first reflective layer 101b and the second reflective layer 102b, the depth-to-width ratio of each reflective layer is great, and it is difficult to form the reflective layer using photolithography, and it will also lead to the high production difficulty for the optical device 100A, which is not conducive to mass production.

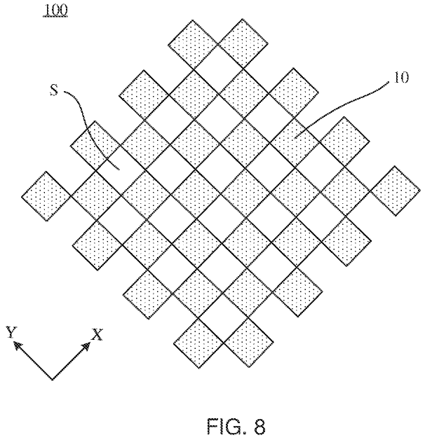

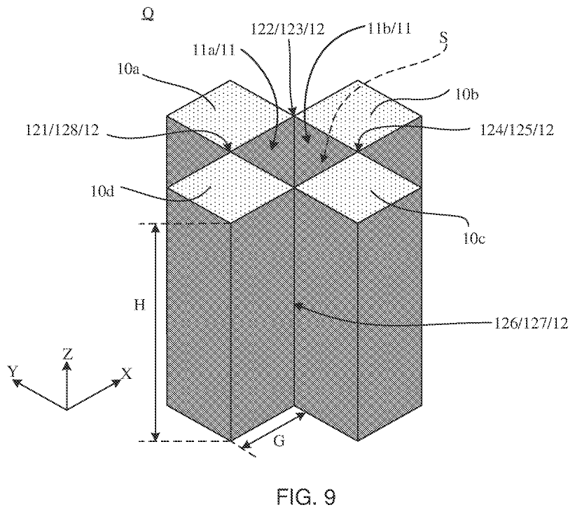

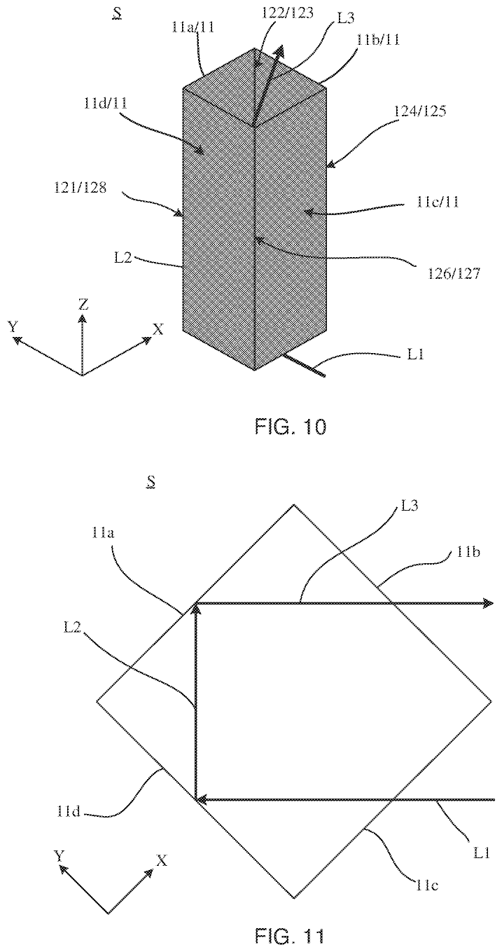

FIG. 7 is a structural diagram of an optical device, in accordance with some embodiments. FIG. 8 is a top view of an optical device, in accordance with some embodiments. FIG. 9 is an enlarged partial view of the Q region in FIG. 7. FIG. 10 is a structural diagram of the optical channel in FIG. 9, and FIG. 11 is a top view of the optical channel in FIG. 9.

FIGS. 7 to 10 are illustrated by taking as an example in which every 4 adjacent reflective pillars 10 define an optical channel S. However, the number of reflective pillars 10 defining an optical channel S is not limited in the present disclosure.

Some embodiments of the present disclosure further provide an optical device 100. Referring to FIGS. 7 and 8, the optical device 100 includes a plurality of reflective pillars 10 extending in a first direction, and the plurality of reflective pillars 10 are arranged in a plurality of rows and a plurality of columns. The first direction is perpendicular to both a row direction and a column direction.

For example, the first direction is parallel to a Z-axis direction, the row direction is parallel to an X-axis direction, and the column direction is parallel to a Y-axis direction.

Every at least three adjacent reflective pillars 10 define an optical channel S extending in the first direction. Each optical channel S includes a plurality of reflective surfaces 11 arranged along a circumferential direction of the optical channel S, and the plurality of reflective surfaces 11 defining the optical channel S are respectively located on different reflective pillars 10.

It will be understood that the reflective surfaces of every adjacent at least three reflective pillars 10 may define an optical channel S. Among the plurality of reflective pillars 10 that define an optical channel S, side edges 12 of two adjacent reflective pillars 10 are oppositely arranged, rather than side surfaces 12 of two adjacent reflective pillars 10 being oppositely arranged. With this arrangement, in a case where side edges of multiple reflective pillars 10 are connected in sequence, the widths of the reflective pillars 10 (i.e., the widths of the reflective surfaces 11) may be used to define a hollow region to form the optical channel S.

Among the multiple reflective pillars 10 that define an optical channel S, side edges 12 of two adjacent reflective pillars 10 are arranged opposite to each other. The two “oppositely arranged” side edges 12 may be directly attached or may have a gap therebetween, which will be described in detail below.

Moreover, as shown in FIG. 9, the multiple reflective surfaces 11 forming an optical channel S include two reflective surfaces 11 that are adjacent and perpendicular to each other. The two reflective surfaces 11 that are adjacent and perpendicular to each other may be respectively a reflective surface 11a and a reflective surface 11b. The reflective surface 11a and the reflective surface 11b may form a double-sided mirror structure. The reflective surface 11a may be located on the first reflective pillar 10a, and the reflective surface 11b may be located on the second reflective pillar 10b adjacent to the first reflective pillar 10a.

As shown in FIGS. 10 and 11, the light L1 provided by the external light source is incident into the optical channel S. The light L1 is irradiated onto the reflective surface 11d, and a reflection light L2 is formed after being reflected by the reflective surface 11d; the reflective surface 11d reflects the reflection light L2 to the reflective surface 11a, a reflection light L3 is formed after the reflection light L2 is reflected by the reflective surface 11a, and the reflective surface 11a reflects the reflection light L3 out of the optical channel S, i.e., out of the optical device 100.

Multiple rays of light L1 emitted by the external light source may all propagate along the above path. That is, the multiple rays of light L1 emitted by the external light source may be reflected by the optical device 100 and then converge in the air on the side of the optical device 100 away from the external light source to form a real image (real mirror image).

In some examples, the external light source may be the display apparatus 200 (referring to FIG. 1).

For example, the multiple rays of light provided by the external light source may form a letter “F”, and then the multiple rays of light provided by the external light source are reflected at least twice by the optical device 100 to form a real image (real mirror image) in a shape of the letter “F”.

In conclusion, the optical device 100 provided by some embodiments of the present disclosure includes a plurality of reflective pillars 10. The plurality of reflective pillars 10 are arranged in multiple rows and columns, and the positions of the reflective pillars 10 are adjusted, so that every at least three adjacent reflective pillars 10 define an optical channel S having two reflective surfaces 11 that are adjacent and perpendicular to each other. Thus, it may be satisfied that the multiple rays of light provided by the external light source may be projected onto the air on the side of the optical device 100 away from the external light source after being reflected at least twice by the optical device 100 to form a real image (real mirror image). Moreover, the plurality of reflective pillars 10 in the optical device 100 are arranged in a plurality of rows and a plurality of columns. The optical device 100 has a simple structure and does not require precise cutting and bonding processes. The plurality of reflective pillars 10 may be integrally formed by electroforming or the like, which is conducive to reducing the difficulty of the manufacturing process of the optical device 100 to facilitate mass production.

In some embodiments, referring to FIGS. 7 to 11, the surface roughness Ra of the reflective surface 11 is less than or equal to 0.8 μm.

In a case where the surface roughness Ra of the reflective surface 11 is equal to or approaches 0.8 μm, the surface roughness Ra of the reflective surface 11 is great; that is, the precision requirement for the surface roughness of the reflective surface 11 is low, which may help reduce the process difficulty of the reflective surface 11 of the reflective pillar 10. Moreover, the surface roughness of the reflective surface 11 may also meet the requirements of specular reflection, so that the light incident into the optical channel S may be emitted after being reflected at least twice by two reflective surfaces 11, so as to form a real image (real mirror image) in the air on a side of optical device 100 away from the external light source.

In addition, the less the surface roughness Ra of the reflective surface 11 is, the better the reflection effect of the reflective surface 11 is, and the real image (real mirror image) formed by the projection of the optical device 100 is clearer.

In some examples, the surface roughness Ra of the reflective surface 11 may be any one of 0.2 μm, 0.4 μm, 0.6 μm, or 0.8 μm, and the embodiments of the present disclosure are not limited thereto.

In some embodiments, referring to FIGS. 7 to 11, a material of the reflective pillar 10 includes any one of silver, aluminum and nickel. In a case where the reflective pillar 10 is made of any metal of silver, aluminum, and nickel, the reflective pillar 10 may have a good reflectivity to achieve specular reflection. However, some of the embodiments of the present disclosure are not limited this, and other materials with high reflectivity may also be used to manufacture the reflective pillar 10.

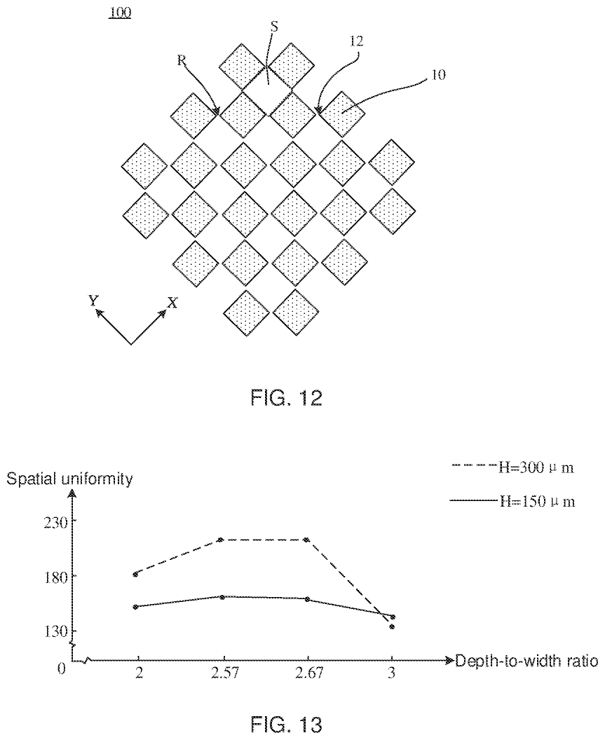

FIG. 12 is a top view of the optical device, in accordance with some embodiments. FIG. 12 is a top view of the optical device 100; in this case, each side edge 12 of each reflective pillar 10 is represented by a vertex on each reflective pillar 10 in FIG. 12.

In some embodiments, as shown in FIG. 12, among the multiple reflective pillars 10 defining an optical channel S, two adjacent reflective pillars 10 are grouped into a group. There is a gap R between two closest side edges 12 of two reflective pillars 10 in at least one group.

Based on this, the gap R between the two side edges 12 may be adjusted to deform the structure of the optical device 100 and improve the applicability of the optical device 100.

In some examples, there is a gap R between two closest side edges 12 of two reflective pillars 10 in each group.

In some other embodiments, referring to FIGS. 7 to 10, in the reflective pillars 10 defining the optical channel S, side edges 12 of every two adjacent reflective pillars 10 are connected to each other to define the optical channel S.

Based on this, an example in which every 4 adjacent reflective pillars 10 define an optical channel S will be described. Each reflective pillar provides a reflective surface 11, so that 4 reflective surfaces 11 are used to define the optical channel S. Each reflective surface 11 includes two sides that are arranged opposite to each other; two sides of a reflective surface 11 may be two side edges of the reflective pillar 10. A side edge 12 of any reflective pillar 10 is connected to a side edge 12 of a reflecting column 10 adjacent thereto, and the other side edge 12 of the any reflective pillar 10 is connected to a side edge 12 of another reflective pillar 12 adjacent thereto. With such arrangement, adjacent reflective pillars 10 may be connected through side edges 12 to define an optical channel S.

For example, as shown in FIGS. 9 and 10, 4 reflective pillars 10 are a first reflective pillar 10a, a second reflective pillar 10b, a third reflective pillar 10c and the fourth reflective pillar 10d respectively. The first reflective pillar 10a, the second reflective pillar 10b, the third reflective pillar 10c and the fourth reflective pillar 10d are arranged in an annulus.

A reflective surface 11a of the first reflective pillar 10a includes two sides that are arranged in the X-axis direction, the two sides of the reflective surface 11a are respectively two side edges 12 of the first reflective pillar 10a, and the two side edges 12 are respectively a first side edge 121 and a second side edge 122.

A reflective surface 11b of the second reflective pillar 10b includes two sides that are arranged in the Y-axis direction, the two sides of the reflective surface 11b are respectively two side edges 12 of the second reflective pillar 10b, and the two side edges 12 are respectively a third side edge 123 and a fourth side edge 124.

A reflective surface 11c of the third reflective pillar 10c includes two sides that are arranged in the X-axis direction, the two sides of the reflective surface 11c are respectively two side edges 12 of the third reflective pillar 10c, and the two side edges 12 are respectively a fifth side edge 125 and a sixth side edge 126.

A reflective surface 11d of the fourth reflective pillar 10d includes two sides that are arranged in the Y-axis direction, which are respectively two side edges 12 of the fourth reflective pillar 10d, and the two side edges 12 are respectively a seventh side edge 127 and an eighth side edge 128.

Based on this, the first side edge 121 of the first reflective pillar 10a is connected to the eighth side edge 128 of the fourth reflective pillar 10d; the second side edge 122 of the first reflective pillar 10a is connected to the second the third side edge 123 of the second reflective pillar 10b. The fourth side edge 124 of the second reflective pillar 10b is connected to the fifth side edge 125 of the third reflective pillar 10c. The sixth side edge 126 of the third reflective pillar 10c is connected to the seventh side edge 127 of the fourth reflective pillar 10d.

With this arrangement, the reflective surface 11a of the first reflective pillar 10a, the reflective surface 11b of the second reflective pillar 10b, the reflective surface 11c of the third reflective pillar 10c, and the reflective surface 11d of the fourth reflective pillar 10d may be used to define the optical channel S, and the reflective surface 11a of the first reflective pillar 10a, the reflective surface 11b of the second reflective pillar 10b, the reflective surface 11c of the third reflective pillar 10c and the reflective surface 11d of the fourth reflective pillar 10d are connected in sequence, which may prevent the light propagating in the optical channel S from being emitted through the gaps between the reflective surfaces 11 and reduce the light loss, so as to prevent the impact on the brightness of the real image (real mirror image) formed in the air after the light is projected by the optical device 100.

In addition, for the multiple reflective pillars 10 forming the optical channel S, two adjacent reflective pillars 10 are connected to each other. Thus, the optical device 100 may be integrally formed by electroforming without the need for precise cutting and attaching processes, which may help reduce the difficulty of the manufacturing process and facilitate mass production.

In some embodiments, referring to FIGS. 7 to 10, every 4 adjacent reflective pillars 10 define an optical channel S. The optical channel S includes 4 reflective surfaces 11 arranged in the circumferential direction of the optical channel S, and an included angle between planes where every two adjacent reflective surfaces 11 are respectively located is a right angle.

As shown in FIGS. 9 and 10, every 4 adjacent reflective pillars 10 define an optical channel S. The 4 reflective pillars 10 are a first reflective pillar 10a, a second reflective pillar 10b, a third reflective pillar 10c and the fourth reflective pillar 10d in sequence. The first reflective pillar 10a, the second reflective pillar 10b, the third reflective pillar 10c and the fourth reflective pillar 10d are arranged in an annulus to define an optical channel S.

In the first reflective pillar 10a, the second reflective pillar 10b, the third reflective pillar 10c and the fourth reflective pillar 10d, the included angle between the planes where every two adjacent reflective surfaces 11 are located is a right angle.

The reflective surface 11a of the first reflective pillar 10a is arranged adjacent to both the reflective surface 11b of the second reflective pillar 10b and the reflective surface 11d of the fourth reflective pillar 10d. That is, an included angle between a plane where the reflective surface 11a of the first reflective pillar 10a is located and a plane where the reflective surface 11b of the second reflective pillar 10b is located is a right angle; an included angle between the plane where the reflective surface 11a of the first reflective pillar 10a is located and a plane where the reflective surface 11d of the fourth reflective pillar 10d is located is a right angle.

The reflective surface 11c of the third reflective pillar 10c is arranged adjacent to both the reflective surface 11b of the second reflective pillar 10b and the reflective surface 11d of the fourth reflective pillar 10d. That is, an included angle between a plane where the reflective surface 11c of the third reflective pillar 10c is located and the plane where the reflective surface 11b of the second reflective pillar 10b is located is a right angle; an included angle between the plane where the reflective surface 11c of the third reflective pillar 10c is located and the plane where the reflective surface 11d of the fourth reflective pillar 10d is located is a right angle.

In the optical device 100, by setting the included angle between the planes where every two adjacent reflective surfaces 11 in the optical channel S are located to be a right angle, every two adjacent reflective surfaces 11 may constitute a “two-surface mirror” structure. Furthermore, when the optical device 100 is used for aerial projection, the light emitted by the external light source, whether irradiated to any reflective surface 11 in any optical channel S in the optical device 100, may be reflected to another reflective surface 11 in the optical channel S adjacent to and perpendicular to the any reflective surface 11, and then be reflected out of the optical device 100 to form a real image (real mirror image) in the air.

Based on this, it may be possible to help prevent the problem that the light cannot be reflected out of the optical device 100, so that the light loss in the optical device 100 is reduced. Moreover, the light reflected by the optical device 100 may be concentrated, which is beneficial to improving the clarity and brightness of the real image (real mirror image).

In addition, since any two adjacent reflective surfaces 11 in the optical channel S may constitute a “two-surface mirror” structure, no matter the external light source is located above or below the optical device 100, the light provided by the external light source may be irradiated onto a “two-surface mirror” structure in the optical channel S. Thus, the relative positional relationship between the optical device 100 and the external light source may be made flexible.

In some other embodiments, in the optical device 100, every five adjacent reflective pillars 10 define an optical channel S. The optical channel S includes 5 reflective surfaces 11 arranged along the circumferential direction of the optical channel S, and the 5 reflective surfaces 11 defining the optical channel S include two reflective surfaces 11 that are adjacent and perpendicular to each other.

Alternatively, in some other embodiments, in the optical device 100, every 3 adjacent reflective pillars 10 define an optical channel S. The optical channel S includes 3 reflective surfaces 11 arranged along the circumferential direction of the optical channel S, and the 3 reflective surfaces 11 defining the optical channel S include two reflective surfaces 11 that are adjacent and perpendicular to each other.

The number of reflective pillars 10 defining the optical channel S will not be limited in the embodiments of the present disclosure.

In some embodiments, referring to FIGS. 7 to 10, widths of all reflective surfaces 11 defining an optical channel S in the circumferential direction of the optical channel S are equal.

An example in which every 4 adjacent reflective pillars 10 define an optical channel S will be described. As shown in FIGS. 9 and 10, 4 reflective pillars 10 are respectively a first reflective pillar 10a, a second reflective pillar 10b, a third reflective pillar 10c and a fourth reflective pillar 10d, and a reflective surface 11a of the first reflective pillar 10a, a reflective surface 11b of the second reflective pillar 10b, a reflective surface 11c of the third reflective pillar 10c, and a reflective surface 11b of the fourth reflective pillar 10d define an optical channel S.

In a case where a width of each reflective surface 11 defining an optical channel S in a circumferential direction of the optical channel S is equal, it may be understood that a width of the reflective surface 11a of the first reflective pillar 10a in the X-axis direction, a width of the reflective surface 11b of the second reflective pillar 10b in the Y-axis direction, a width of the reflective surface 11c of the third reflective pillar 10c in the X-axis direction, and a width of the reflective surface 11d of the fourth reflective pillar 10d in the Y-axis direction are all equal, so that the optical channel S has a square tube structure.

Based on this, every two adjacent reflective surfaces 11 in the optical channel S may constitute a “two-surface mirror” structure with equal side lengths. When being irradiated into the optical channel S in the optical device 100, the light emitted by the external light source may be reflected at least twice in the optical channel S and then exit from the optical device 100 to form a real image (real mirror image) in the air, and the real image (real mirror image) and the external light source are arranged symmetrically with the optical device 100 as a symmetry axis.

In addition, the widths of the reflective surfaces 11 of the multiple reflective pillars 10 defining the optical channel S are equal. It is possible to help reduce the process difficulty of forming each reflective pillar 10 in the optical device 100, which is suitable for mass production.

In some embodiments, referring to FIGS. 7 to 10, the reflective pillar 10 is in a shape of a quadrangular prism, which may help reduce the manufacturing difficulty of the optical device 100 and shorten the process.

In a case where the reflective pillar 10 is in a shape of a quadrangular prism, each quadrangular prism includes 4 side edges, and each side edge may be connected to a side edge of a reflective pillar 10 adjacent thereto. That is, each reflective pillar 10 may be connected to side edges of 4 adjacent reflective pillars 10 by using 4 side edges, so that every 4 reflective pillars 10 define an optical channel S.

In some examples, the reflective pillar 10 may be in a shape of a regular quadrangular prism.

Each reflective pillar 10 in the optical device 100 has the same shape, so that in a case where the reflective pillar 10 is in the shape of a regular quadrangular prism, the widths of the reflective surfaces in all the reflective pillars 10 in the optical device 100 are equal. Furthermore, in a case where 4 adjacent reflective pillars 10 are connect through side edges of each reflective pillar 10 to define an optical channel S, the width of each reflective surface 11 in the optical channel S is equal. Moreover, since the reflective pillar 10 is in a shape of a regular quadrangular prism, the optical channel S defined by 4 reflective pillars 10 may be of a square tube structure. That is, every two adjacent reflective surfaces 11 in the optical channel S are perpendicular to each other and have the same width.

Based on this, when being irradiated into the optical channel S in the optical device 100, the light emitted by an external light source may be reflected approximately twice in the optical channel S, and then exit from the optical device 100 to form a real image (real mirror image) in the air. Thus, the light reflected by the optical device 100 may be concentrated, which is beneficial to improving the clarity and brightness of the real image (real mirror image).

In some embodiments, referring to FIGS. 7 to 10, a depth-to-width ratio of the reflective pillar 10 is in a range of 1:1 to 3:1, inclusive. The length of the reflective pillar 10 in the Z-axis direction is the depth of the reflective pillar. The length of the reflective pillar 10 in the X-axis direction or Y-axis is the width of the reflective pillar 10.

As shown in FIG. 9, considering the fourth reflective pillar 10d as an example for introduction, the depth of the fourth reflective pillar 10d in the Z-axis direction is H, and the width of the fourth reflective pillar 10d in the X-axis direction is G. H: G is in a range of 1:1 to 3:1, inclusive.

In a case where the depth-to-width ratio of the reflective pillar 10 is equal to or approaches 1:1, the depth of the reflective pillar 10 is equal to the width of the reflective pillar 10. The depth of the reflective pillar 10 is small, i.e., the length, in the Z-axis direction, of the optical channel S defined by the multiple reflective pillars 10 is small, which may satisfy the requirement that the light incident into the optical channel S is reflected twice before being emitted from the optical device 100. Moreover, it may be possible to avoid the problem of light loss due to a case that the light incident into the optical channel S is not emitted after being reflected twice and needs to be reflected multiple times before being emitted from the optical device 100, caused by a fact that the optical channel S is too long.

In a case where the depth-to-width ratio of the reflective pillar 10 is equal to or approaches 1:3, the depth of the reflective pillar 10 is three times the width of the reflective pillar 10. The depth of the reflective pillar 10 is relatively great, i.e., the length, in the Z-axis direction, of the optical channel S defined by the multiple reflective pillars 10 is great, which may satisfy the requirement that the light incident into the optical channel S is reflected twice before being emitted from the optical device 100. Moreover, it may be possible to prevent the problem of unclear or low brightness of the real image in the air (real mirror image) due to a case that the light incident into the optical channel S is not able to undergo two reflections and cannot emitted from the optical device 100, caused by a fact that the optical channel S is too short.

In addition, the depth-to-width ratio of the reflective pillar 10 is in a range of 1:1 to 3:1, inclusive, and a difference between the depth and width of the reflective pillar 10 is small. Compared with film layers with a depth-to-width ratio of several hundred, it is possible to help reduce the process difficulty and facilitate mass production.

In some examples, the depth-to-width ratio of the reflective pillar 10 may be any one of 1:1, 1:2, or 1:3, and the present disclosure is not limited thereto.

In some embodiments, referring to FIGS. 7 to 10, the depth of the reflective pillar 10 in the first direction is in a range of 100 μm to 600 μm, inclusive. The first direction is parallel to the Z-axis direction.

In a case where the depth of the reflective pillar 10 in the Z-axis direction is equal to or approaches 100 μm, the depth of the reflective pillar 10 is relatively small, i.e., the length, in the Z-axis direction, of the optical channel S defined by the multiple reflective pillars 10 is small, it may be possible to satisfy the requirement that the light incident into the optical channel S is reflected twice before being emitted from the optical device 100. Moreover, it may be possible to avoid the problem of light loss due to a case that the light incident into the optical channel S is not emitted after being reflected twice and needs to be reflected multiple times before being emitted from the optical device 100, caused by a fact that the optical channel S is too long.

In a case where the depth of the reflective pillar 10 in the Z-axis direction is equal to or approaches 600 μm, the depth of the reflective pillar 10 is relatively great, i.e., the length, in the Z-axis direction, of the optical channel S defined by the multiple reflective pillars 10 is great, it may be possible to satisfy the requirement that the light incident into the optical channel S is reflected twice before being emitted from the optical device 100. Moreover, it may be possible to prevent the problem of unclear or low brightness of the real image in the air (real mirror image) due to a case that the light incident into the optical channel S is not able to undergo two reflections and cannot emitted from the optical device 100, caused by a fact that the optical channel S is too short.

In some examples, the depth, in the first direction, of the reflective pillar 10 may be any of 100 μm, 200 μm, 300 μm, 400 μm, 500 μm, or 600 μm, and the present disclosure is not limited thereto.

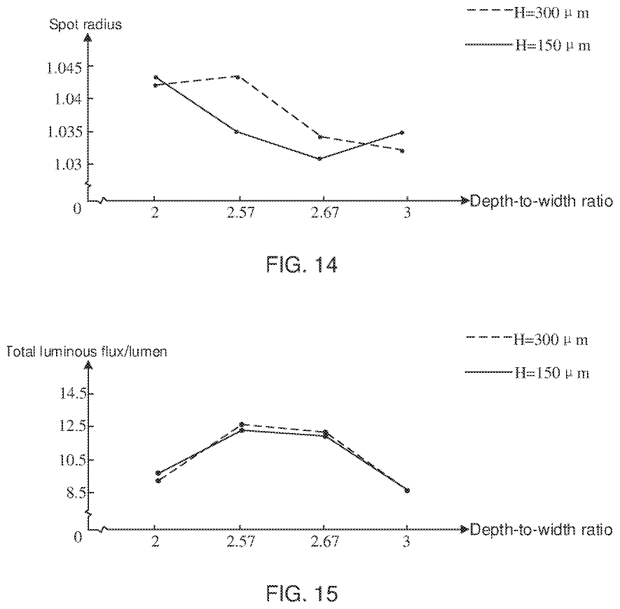

FIG. 13 is a broken line graph of spatial uniformity of the real image projected by the optical device, in accordance with some embodiments. FIG. 14 is a broken line graph of a spot radius of the real image projected by the optical device, in accordance with some embodiments. FIG. 15 is a broken line graph of a total luminous flux of the real image projected by the optical device, in accordance with some embodiments.

In some embodiments of the present disclosure, by adjusting the depth-to-width ratio of the reflective pillar 10 and the depth, in the first direction, of the reflective pillar 10, the results of the real image in the air (real mirror image) are simulated and verified. The results obtained through simulation verification are shown in FIGS. 13 to 15, and as shown in Tables 1 to 3 below.

Based on the external light source, the positions of the optical device 100 and the external light source, and other parameters remaining unchanged, in a case where the depth H of the reflective pillar 10 is 150 μm and 300 μm, the depth-to-width ratio of the reflective pillar 10 is adjusted, and the changes of the spatial uniformity, the spot radius, and the total luminous flux of the real image (real mirror image) projected by optical device 100 are obtained through the simulation. That is, in a case where only the depth and depth-to-width ratio of the reflective pillar 10 are adjusted, the changes of the spatial uniformity, spot radius, and total luminous flux of the real image (real mirror image) projected by the optical device 100 are obtained.

For example, the spatial uniformity of the real image refers to a standard deviation of all non-zero pixel data. That is, the greater the standard deviation, the greater the difference between all pixels (points) representing the real image, and the worse the imaging effect of the real image. Moreover, the smaller the standard deviation, the smaller the difference between all the pixels (points) representing the real image, and the better the imaging effect of the real image. The non-zero pixel data represents an imaging state of all rays of light that can be reflected by the optical device 100 to an area to be projected in the multiple rays of light provided by the light source. For example, the non-zero pixel data represents the imaging brightness of all the rays of light that can be reflected by the optical device 100 to an area to be projected in the multiple rays of light provided by the light source.

For example, the spot radius of the real image refers to a root mean square (RMS) radius. It will be understood that in a case where the multiple rays of light provided by the external light sources are reflected by the optical device 100 to the area to be projected, a radius of an aperture formed by the light is greater than a radius of an aperture of the light that is not reflected, which is equivalent to the light is amplified after being reflected by the optical device 100, resulting in a problem of blurring and unclear after the light is reflected by the optical device 100. Based on this, the spot radius of the real image is small, i.e., the spot radius of the multiple light that is reflected and forming the real image is small, so that the spot radius of the real image is close to the spot radius of the light that has not been reflected by the optical device 100 or less than the spot radius of the light that has not been reflected by the optical device 100, and thus, it is possible to help improve the clarity of the real image.

For example, the total luminous flux of the real image refers to the achieved brightness. The greater the total luminous flux of the real image, the greater the achieved brightness, which is beneficial to improving the imaging effect of the real image.

For the real image (real mirror image), the smaller the spatial uniformity, the smaller the spot radius, and the greater the total luminous flux, the better the imaging effect of the real image (real mirror image). As shown in Tables 1 to 3 and FIGS. 13 to 15, in a case where the depth H of the reflective pillar 10 is approximately 150 μm and the depth-to-width ratio of the reflective pillar 10 is approximately 2.67, the spatial uniformity, spot radius and total luminous flux of the real image (real mirror image) are all in a good state. That is, in a case where the depth H of the reflective pillar 10 is approximately 150 μm and the depth-to-width ratio of the reflective pillar 10 is approximately 2.67, the imaging effect of the real image (real mirror image) is good.

Based on this, the depth, in the first direction, of the reflective pillar 10 may be set to approximately 150 μm, and the depth-to-width ratio of the reflective pillar 10 may be set to approximately 2.67, so that the formed optical device 100 has a good imaging effect.

It will be noted that due to certain uncontrollable errors (e.g., manufacturing process errors, or equipment accuracy), the fluctuation of the depth of the reflective pillar 10 does not exceed 5%×150 μm, which is considered that the depth H of the reflective pillar 10 may be approximately 150 μm. Correspondingly, the depth-to-width ratio of the reflective pillar 10 is also the same as above, and the fluctuation does not exceed 5%×2.67, which may be considered that the depth-to-width ratio of the reflective pillar 10 is approximately 2.67.

Moreover, the specific value of the error threshold will not be limited in some of the embodiments of the present disclosure.

TABLE 1
Spatial uniformity of the real image (real mirror image) varies
with a depth and depth-to-width ratio of the reflective pillar

| Depth-to-width | Depth of | Depth of |
|---|---|---|
| ratio of the | the reflective | the reflective |
| reflective pillar | pillar H = 150 μm | pillar H = 300 μm |
| 3 | 141.543 | 134.25 |
| 2.67 | 157.384 | 213.579 |
| 2.67 | 159.107 | 212.979 |
| 2 | 150.731 | 181.169 |

TABLE 2
Spot radius of the real image (real mirror image) varies with
a depth and depth-to-width ratio of the reflective pillar

| Depth-to-width ratio | Depth of the reflective | Depth of the reflective |
|---|---|---|
| of the reflective pillar | pillar H = 150 μm | pillar H = 300 μm |
| 3 | 1.035 | 1.032 |
| 2.67 | 1.031 | 1.034 |
| 2.67 | 1.035 | 1.043 |
| 2 | 1.043 | 1.042 |

TABLE 3
Total luminous flux of the real image (real mirror image) varies
with a depth and depth-to-width ratio of the reflective pillar

| Depth-to-width ratio | Depth of the | Depth of the |
|---|---|---|
| of the | reflective pillar | reflective pillar |
| reflective pillar | H = 150 μm | H = 300 μm |
| 3 | 8.694 lumens | 8.75 lumens |
| 2.67 | 12.139 lumens | 12.373 lumens |
| 2.67 | 12.41 lumens | 12.776 lumens |
| 2 | 9.754 lumens | 9.349 lumens |

In some embodiments, the optical device 100 includes a plurality of optical channels S. The spatial uniformity of multiple rays of light reflected by the plurality of optical channels S is in a range of 100 to 250, inclusive. That is, the spatial uniformity of the real image formed by the multiple rays of light reflected by the optical device 100 is in a range of 100 to 250, inclusive.

In the case where the depth-to-width ratio of the reflective pillar 10 is in the range of 1:1 to 3:1, and the depth of the reflective pillar 10 in the first direction is in the range of 100 μm to 600 μm, it is possible to ameliorate the problem of blurry and unclear of the real image formed by the reflection of optical device 100 at certain points (pixels) caused by a case that certain rays of light provided by the external light source are not reflected to the position to be imaged, so as to reduce the imaging difference, at various positions, of the real image formed by the reflection of optical device 100. Thus, it is possible to achieve that the spatial uniformity of the real image formed after reflection by the optical device 100 is in the range of 100 to 250, so that the spatial uniformity of the real image formed after reflection by the optical device 100 is small, which is beneficial to improving the imaging effect of the optical device 100.

In some examples, the spatial uniformity of the real image formed after reflection by the optical device 100 is in a range of 100 to 220, which may further reduce the imaging difference, at various positions, of the real image formed after reflection by the optical device 100, which is beneficial to improving the imaging effect of the optical device 100.

For example, the spatial uniformity of the real image formed after reflection by the optical device 100 is approximately any one of 150, 160, 170, 180, 190, 200, 210 or 220, and the embodiments of the present disclosure are not limited thereto.

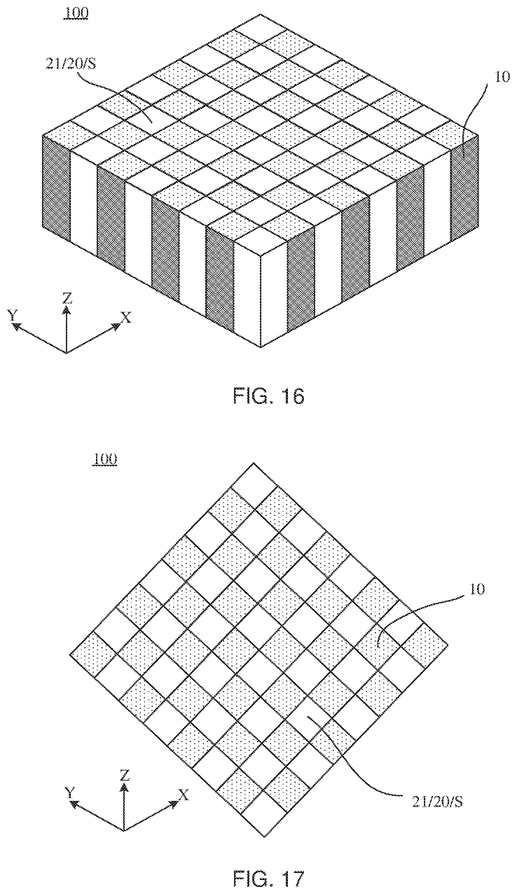

FIG. 16 is yet another structural diagram of the optical device, in accordance with some embodiments. FIG. 17 is yet another top view of the optical device, in accordance with some other embodiments.

In some embodiments, referring to FIGS. 16 and 17, the optical device 100 further includes a transparent support layer 20. The transparent support layer 20 includes a plurality of transparent support portions 21. The transparent support portion 21 is located between adjacent reflective pillars 10 to fill the optical channel S.

The optical device 100 is provided with a transparent support portion 21 between every adjacent reflective pillars 10 to further fix the adjacent reflective pillars 10 by using the transparent support portion 21, so that the stability of the optical device 100 is improved.

In some examples, in the Z-axis direction, a height of the transparent support portion 21 is equal to the depth of the reflective pillar 10. An edge of the transparent support portion 21 in the Z-axis direction is located in a same horizontal plane as an edge of the reflective pillar 10 in the Z-axis direction, and the other edge of the transparent support portion 21 in the Z-axis direction is located in a same horizontal plane as the other edge of the reflective pillar 10 in the Z-axis direction. That is, the plurality of reflective pillars 10 and the plurality of transparent support portions 21 are alternately arranged to form a relatively flat optical device 100.

In some embodiments, as shown in FIGS. 16 and 17, a transmittance of the transparent support layer 20 is greater than or equal to 95%. Since each transparent support portion 21 in the transparent support layer 20 is filled in the optical channel S defined by the multiple reflective pillars 10, the transmittance of the transparent support layer 20 is set to be greater than 95%, it is possible to reduce the impact of the transparent support layer 20 on a transmittance of the optical channel S, so as to reduce the light loss caused by the transparent support layer 20 to the light in the optical channel S.

For example, the transmittance of the transparent support layer 20 is greater than or equal to 98%. In a case where the transmittance of the transparent support layer 20 is equal to or approaches 98%, the transmittance of the transparent support layer 20 is high, which may reduce the impact of the transparent support layer 20 on the transmittance of the optical channel S well, so that the light loss caused by the transparent support layer 20 to the light in the optical channel S is reduced.

In some embodiments, referring to FIGS. 16 and 17, a material of the transparent support layer 20 includes any one of resin, glass cement, and polymethyl methacrylate (PMMA).

The transparent support layer 20 is made of any one of resin, glass cement, and polymethyl methacrylate (PMMA), so that the transparent support layer 20 has a high transmittance and a high hardness. Thus, it may be possible to not only meet the requirement for the transmittance of the transparent support layer 20 to reduce the impact on the light in the optical channel S, but also meet the requirement for the hardness of the transparent support layer 20 to improve the stability of the optical device 100. Moreover, the material of the transparent support layer 20 is not limited in some of the embodiments of the present disclosure.

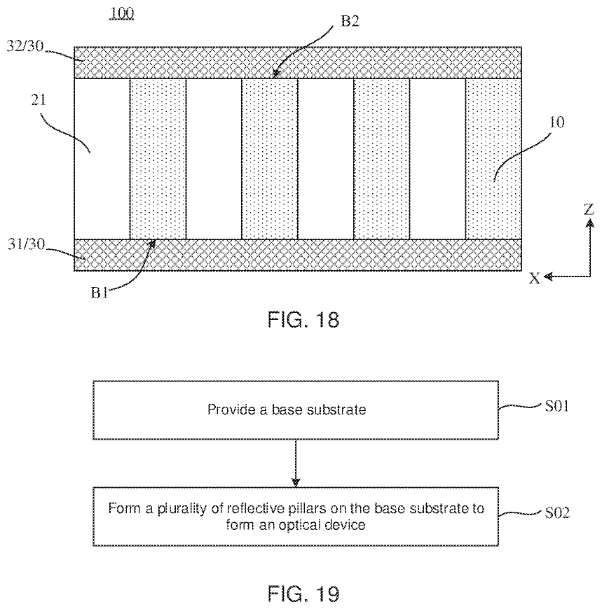

FIG. 18 is a section of the optical device, in accordance with some embodiments.

In some embodiments, referring to FIG. 18, the reflective pillar 10 includes a first surface B1 and a second surface B2 that are arranged oppositely in the first direction. The first direction is parallel to the Z-axis direction, and the row direction is parallel to the X-axis direction.

FIG. 18 is illustrated by considering multiple reflective pillars 10 arranged in the row direction as an example.

The optical device 100 further includes a transparent protective layer 30. The transparent protective layer 30 includes a first transparent protective layer 31. The first transparent protective layer 31 is located on a side of the first surfaces B1 of the plurality of reflective pillars 10 away from the second surfaces B2 of the plurality of reflective pillars 10.

For example, the first surface B1 is closer to the external light source than the second surface B2. Based on this, the first transparent protective layer 31 is located on a side of the reflective pillars 10 proximate to the external light source.

In some examples, in a case where the optical device 100 further includes the transparent support layer 20, the first transparent protective layer 30 is located on a same side of the plurality of transparent support portions 21 and the plurality of reflective pillars 10.

The first transparent protective layer 31 is disposed on the same side of the plurality of reflective pillars 10, it is possible to protect the plurality of reflective pillars 10 by using the first transparent protective layer 31, which may prevent damage such as scratching and breaking, caused by external forces, on the plurality of reflective pillars 10 from affecting the reflection effect of the reflective pillars 10. Thus, the imaging effect of the optical device 100 may be ensured.

In some other embodiments, referring to FIG. 18, the transparent protective layer 30 includes a second transparent protective layer 32. The second transparent protective layer 32 is located on a side of the second surfaces B2 of the plurality of reflective pillars 10 away from the first surfaces B1 of the plurality of reflective pillars 10.

For example, the first surface B1 is closer to the external light source than the second surface B2. Based on this, the second transparent protective layer 32 is located on a side of the reflective pillars 10 away from the external light source.

In some examples, in a case where the optical device 100 further includes a transparent support layer 20, the first transparent protective layer 30 is located on the same side of the plurality of transparent support portions 21 and the plurality of reflective pillars 10.

The second transparent protective layer 32 is disposed on the same side of the plurality of reflective pillars 10, it is possible to protect the plurality of reflective pillars 10 by using the second transparent protective layer 32, which may prevent damage such as scratching and breaking, caused by external forces, on the plurality of reflective pillars 10 from affecting the reflection effect of the reflective pillars 10. Thus, the imaging effect of the optical device 100 may be ensured.

In some other embodiments, referring to FIG. 18, the transparent protective layer 30 includes a first transparent protective layer 31 and a second transparent protective layer 32. The first transparent protective layer 31 is located on the side of the first surfaces B1 of the plurality of reflective pillars 10 away from the second surfaces B2, and the second transparent protective layer 32 is located on the side of the second surfaces B2 of the plurality of reflective pillars 10 away from the first surfaces B1. That is, in the first direction, the plurality of reflective pillars 10 are located between the first transparent protective layer 31 and the second transparent protective layer 32.

The plurality of reflective pillars 10 are sandwiched between the first transparent protective layer 31 and the second transparent protective layer 32, i.e., the plurality of reflective pillars are provided with a protective layer on both above and below thereof, it is possible to jointly protect the plurality of reflective pillars 10 by using the first transparent protective layer 31 and the second transparent protective layer 32, and may further prevent the plurality of reflective pillars 10 from being scratched, broken or other damaged caused by external forces.

In some embodiments, referring to FIG. 18, a refractive index of the transparent protective layer 30 is substantially equal to a refractive index of the transparent support layer 20.

The refractive index of the transparent protective layer 30 is set to be substantially equal to the refractive index of the transparent support layer 20, it is possible to prevent the problems of divergence and unclear of the real image (real mirror image) due to the shift of the real image (real mirror image) formed in the air, which is caused by a fact that the light is refracted at an interface between the transparent support layer 20 and the transparent protective layer 30 due to the great difference in the refractive indexes of the transparent protective layer 30 and the transparent support layer 20. Moreover, there is a certain degree of light loss after the light is refracted multiple times. Based on this, the refractive index of the transparent protective layer 30 is set to be substantially equal to the refractive index of the transparent support layer 20, which may help reduce the light loss of the light passing through the optical device 100 and ensure the imaging effect of the real image (real mirror image) formed in the air.

It will be noted that due to certain uncontrollable errors (e.g., manufacturing process errors, or equipment accuracy) or differences in the selection of the respective materials, the fluctuation of the difference between the refractive index of the transparent protective layer 30 and the refractive index of the transparent support layer 20 does not exceed an error threshold, which may also be considered that the refractive index of the transparent protective layer 30 is substantially equal to the refractive index of the transparent support layer 20. The error threshold may be 5% of the refractive index value of the one with the smaller refractive index of the transparent protective layer 30 and the transparent support layer 20. Moreover, the specific value of the error threshold will not be limited in some of the embodiments of the present disclosure.

In some embodiments, referring to FIG. 18, the transmittance of the transparent protective layer 30 is greater than or equal to 95%. The transparent protective layer 30 covers the transparent supporting layer 20, that is, the transparent protective layer 30 covers the optical channels S. Thus, the transmittance of the transparent protective layer 30 is set to be greater than or equal to 95%, which may reduce the impact of the transparent protective layer 30 on the transmittance of the optical channel S to reduce the light loss caused by the transparent protective layer 30 to the light in the optical channel S.

In some examples, the transmittance of the transparent protective layer 30 is greater than or equal to 98%. In a case where the transmittance of the transparent protective layer 30 is equal to or approaches 98%, the transmittance of the transparent protective layer 30 is high, which may reduce the impact of the transparent protective layer 30 on the transmittance of the optical channel S well, so that the light loss caused by the transparent protective layer 30 to the light in the optical channel S is reduced.

In some embodiments, referring to FIG. 18, a material of the transparent protective layer 30 may be any one of inorganic glass or organic glass.

The transparent protective layer 30 may be formed by either inorganic glass or organic glass, so that the transparent protective layer 30 may have a high transmittance and a high hardness. Thus, it may be possible to not only meet the requirement for the transmittance of the transparent protective layer 30 to reduce the impact on the light in the optical channel S, but also meet the requirement for the hardness of the transparent protective layer 30 to improve the stability of the optical device 100.

In some examples, the material of the transparent protective layer 30 is inorganic glass. For example, the inorganic glass may be glass.

In some other examples, the material of the transparent protective layer 30 may be organic glass. For example, the material of the transparent protective layer 30 may be polymethyl methacrylate (PMMA).

Moreover, the material of the transparent protective layer 30 is not limited in some of the embodiments of the present disclosure.

FIG. 19 is a flow diagram of a manufacturing method of an optical device, in accordance with some embodiments.

Some embodiments of the present disclosure provide a manufacturing method of an optical device. As shown in FIG. 7, the optical device 100 includes a plurality of reflective pillars 10 extending in a first direction, and the plurality of reflective pillars 10 are arranged in multiple rows and multiple columns. The first direction is perpendicular to both a row direction and a column direction.

For example, the first direction is parallel to a Z-axis direction, the row direction is parallel to an X-axis direction, and the column direction is parallel to a Y-axis direction.

Every at least three adjacent reflective pillars 10 define an optical channel S extending in the first direction. Each optical channel S includes a plurality of reflective surfaces 11 arranged along a circumferential direction of the optical channel S, and the plurality of reflective surfaces 11 defining the optical channel S are respectively located on different reflective pillars 10.

As shown in FIG. 19, the manufacturing method of the optical device 100 includes following steps.

In S01, a base substrate is provided.

For example, the base substrate may be a glass base substrate, a metal base substrate or a silica-based base substrate. The specific type of the base substrate will be described in detail below.

In S02, a plurality of reflective pillars are formed on the base substrate to form an optical device.

For example, the plurality of reflective pillars may be formed on the base substrate to form the optical device. Alternatively, the plurality of reflective pillars may be formed in the base substrate to form the optical device. How to form the optical device will be described in detail below.

In the manufacturing method of the optical device in some embodiments of the present disclosure, the plurality of reflective pillars are formed on the base substrate to form the optical device 100. In the formed optical device 100, the light provided by the external light source may be illuminated into a space defined by at least three adjacent reflective pillars 10, and then illuminated on the reflective pillar 10, and the light is exited from optical device 100 after being reflected by at least two reflective pillars 10, and then forms a real image (real mirror image) in the air on a side of the optical device 100 away from the external light source.

The following will be introduced with reference to the accompanying drawings by taking an example in which the base substrate includes a transparent base substrate.

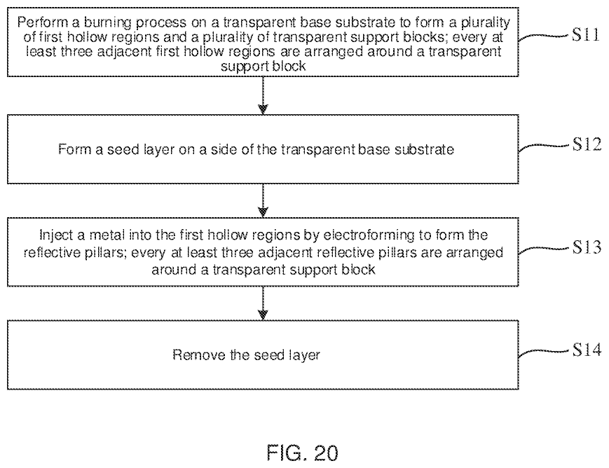

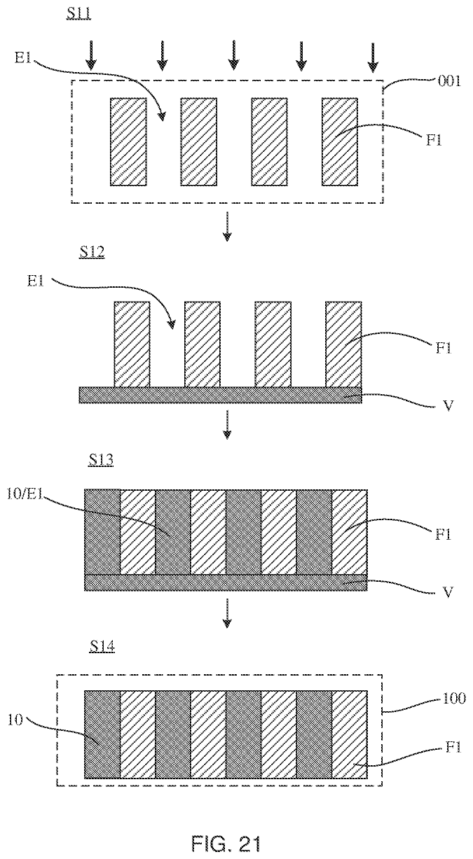

FIG. 20 is a flow diagram of some steps in FIG. 19, and FIG. 21 is a structural diagram of some steps in FIG. 20.

Referring to FIGS. 20 and 21, in the step S01, the base substrate includes a transparent base substrate 001. The step S02 in which the plurality of reflective pillars are formed on the base substrate includes the following steps.

In S11, a burning process is performed on the transparent base substrate 001 to form a plurality of first hollow regions E1 and a plurality of transparent support blocks F1; every at least three adjacent first hollow regions E1 are arranged around a transparent support block F1.

In S12, a seed layer V is formed on a side of the transparent base substrate 001. The seed layer V may be used as an electroforming master used in a subsequent electroforming process.

In some examples, the seed layer V may be attached to a side of the transparent base substrate 001 that after performing the burning process. The formation method of the seed layer will not be limited in the embodiments of the present disclosure.

In some examples, a material of the seed layer V may be copper or titanium. Based on this, the seed layer V may have a good conductivity, so as to promote the growth of metal on the seed layer V to form the reflective pillars 10. The material of the seed layer V is not limited in some of the embodiments of the present disclosure.

In S13, a metal is injected into the first hollow regions E1 by electroforming to form the reflective pillars 10; every at least three adjacent reflective pillars 10 are arranged around a transparent support block F1.

In the step S13, metal is injected into the first hollow region E1 by electroforming until reaching the seed layer V therebelow to form the reflective pillars 10 on the seed layer V.

In some examples, the injected metal may be a metal with a high reflectivity. Based on this, the reflective pillars made of the metal may be made to have a high reflectivity, and the loss of light caused by the optical device 100 may be reduced. For example, the injected metal may be silver or nickel.

In S14, the seed layer V is removed. In some examples, the seed layer V may be removed by means of grinding to form the optical device 100. The manner of removing the seed layer V is not limited in some of the embodiments of the present disclosure.

In the manufacturing method of the optical device provided by some embodiments of the present disclosure, a burning process is performed on the transparent base substrate 001, so that the base substrate 001 forms the plurality of first hollow regions E1 and the plurality of transparent support blocks F1. The plurality of first hollow regions E1 and the plurality of transparent support blocks F1 are arranged in a checkerboard structure, so that every adjacent at least three first hollow regions E1 are arranged around a transparent support block F1. The patterned base substrate 001 is then attached to the seed layer V, and the seed layer V is used to form a master for electroforming. The metal is injected into the first hollow regions E1 by electroforming to form the reflective pillars 10. In this case, the plurality of reflective pillars 10 and the plurality of transparent support blocks F1 are arranged in a checkerboard structure, so that every at least three adjacent reflective pillars 10 are arranged around a transparent support block F1 to form the optical device 100.

In the formed optical device 100, every at least three adjacent reflective pillars 10 surrounds a transparent support block F1, and thus, when the optical device 100 performs aerial projection, the light provided by the external light source may illuminate onto the transparent support block F1, and illuminate onto the reflective pillar 10 adjacent to the transparent support block F1; the light propagates in the transparent support block F1 after being reflected by the reflective pillar 10, and illuminate onto another reflective pillar 10, and is emitted from the transparent support block F1, i.e., emitted from the optical device 100, after being reflected again; and then, a real image (real mirror image) is formed in the air on the side of the optical device 100 away from the external light source.

In addition, in the manufacturing method of the optical device provided by some embodiments of the present disclosure, by burning the transparent base substrate 001 and injecting the metal into the transparent base substrate 001 by electroforming, the plurality of reflective pillars 10 are integrally formed. Thus, compared with the precise cutting and attaching processes, the manufacturing method has a simple process, which is conducive to mass production.

In some embodiments, a transmittance of the transparent base substrate 001 is greater than or equal to 95%. Every at least three adjacent reflective pillars 10 surrounds a transparent support block F1, when the optical device 100 performs aerial projection, the light provided by the external light source may illuminate onto the transparent support block F1, and propagates in the transparent support block F1. Thus, the transmittance of the transparent base substrate 001 is set to be large, which may reduce the light loss caused by the transparent support block F1 to the light.

In some embodiments, as shown in FIGS. 16 and 17, in a case where the optical device 100 includes a transparent support layer 20, the transparent support layer 20 includes a plurality of transparent support portions 21. The transparent support blocks F1 serve as the transparent support portions 21.

For example, a material of the transparent base substrate 001 includes any one of resin, glass cement, and polymethyl methacrylate (PMMA). The transparent base substrate 001 is made of any one of resin, glass cement, and polymethyl methacrylate (PMMA), so that the transparent base substrate 001 has a high transmittance and a high hardness. It is possible not only to meet the requirements for the transmittance of the transparent base substrate 001 to reduce the impact of the transparent base substrate 001 on light, and also meet the requirements for the hardness of the transparent base substrate 001 to improve the stability of the optical device 100. The material of the transparent base substrate 001 is not limited in some of the embodiments of the present disclosure.

In some other embodiments, the manufacturing method of the optical device, after step S13 and before step S14, further includes step S131 in which the transparent support blocks F1 are removed and the reflective pillars 10 are retained to form the optical device 100.

Based on this, the transparent support block F1 is removed, so that a hollow region may be formed, and the hollow region may serve as the optical channel S. Furthermore, every at least three adjacent reflective pillars 10 may be arranged around an optical channel S formed by removing the transparent support block F1. Thus, the light propagates in the optical channel S, is reflected on the adjacent reflective pillar 10 in the optical channel S, and is emitted from the optical device 100 after being reflected at least twice to form a real image (real mirror image) in the air.

In some embodiments, in the manufacturing method of the optical device, in the step S14, after removing the seed layer V, the reflective pillars 10 may be encapsulated to form the optical device 100.

In some examples, an encapsulation film layer may be formed on both sides in the extending direction of the reflective pillars 10, so that the encapsulation film layer may protect the reflective pillars 10 to prevent the reflective pillars 10 from being scratched, so as to ensure the reflection effect of the reflective pillars 10.

For example, as shown in FIG. 18, in a case where the optical device 100 includes a transparent protective layer 30, the encapsulation film layer serves as the transparent protective layer 30.

The above embodiments are described by taking an example in which the base substrate includes a transparent base substrate. The following will be described with reference to the relevant drawings by taking an example in which the base substrate is a metal base substrate or a silicon-based base substrate.

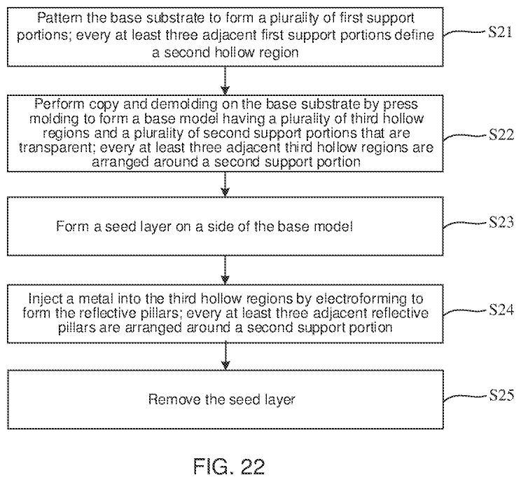

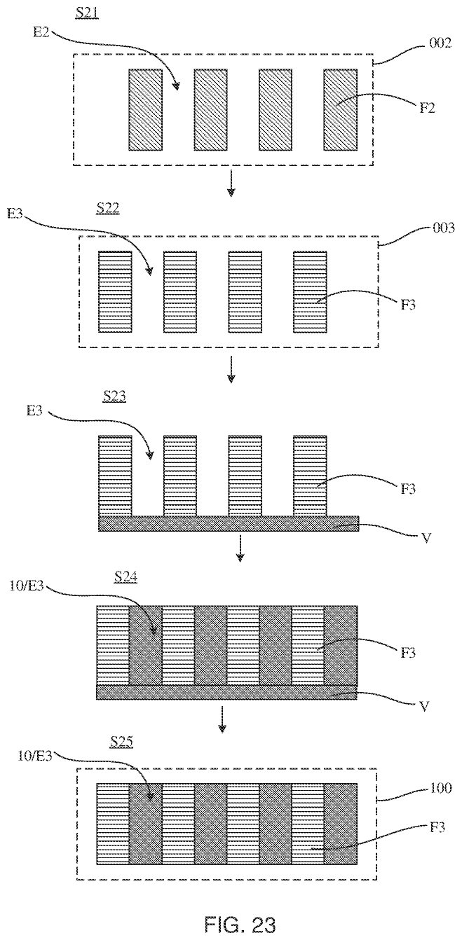

FIG. 22 is another flow diagram of some steps in FIG. 19, and FIG. 23 is a structural diagram of some steps in FIG. 22.

Referring to FIGS. 22 and 23, in the step S01, the base substrate may include a metal base substrate or a silicon-based base substrate. The step S02 in which the plurality of reflective pillars are formed on the base substrate includes the following steps.

In S21, the base substrate 002 is patterned to form a plurality of first support portions F2; every at least three adjacent first support portions F2 define a second hollow region E2.

In some examples, the description will be made by taking an example in which the base substrate 002 in the step S21 is a metal base substrate.

In the step S21, an ultra-precision milling machine may be used to pattern the base substrate 002, so that a plurality of first support portions F2 and a plurality of second hollow regions E2 arranged in a checkerboard structure are formed on the base substrate 002.

Processing the base substrate 002 with an ultra-precision milling cutter to pattern the base substrate 002 may help improve the accuracy of the first support portion F2. An ultra-precision milling machine is used to pattern the base substrate 002 may help improve the roughness and verticality of the surface of the first support portion F2, which facilitates the roughness and verticality of the base model 003 obtained by using the base model 002 in the subsequent process. Based on this, it may also be beneficial to the roughness and verticality of the reflective pillars 10 formed by injecting the metal into the base model 003 by electroforming, so as to improve the imaging effect of the optical device 100.

In some examples, the description will be made by taking an example in which the base substrate 002 in the step S21 is a silicon-based base substrate.

In the step S21, the base substrate 002 may be patterned by using an etching process, so that a plurality of first support portions F2 and a plurality of second hollow regions E2 that are arranged in a checkerboard structure are formed on the base substrate 002. The base substrate 002 is patterned by using a deep silicon etching process, so that the process is simple and it is conducive to mass production.

In S22, copy and demolding are performed on the base substrate 002 by press molding to form a base model 003 having a plurality of third hollow regions E3 and a plurality of second support portions F3 that are transparent; every at least three adjacent third hollow regions E3 are arranged around a second support portion F3.

In some examples, a material with high transmittance needs to be selected as a material forming the base model 003, so that the base model 003 may form the plurality of second support portions F3 that are transparent.

In some examples, a transmittance of the base model 003 is greater than or equal to 95%. For example, the transmittance of the base model 003 is greater than or equal to 98%.

For example, the material of the base model 003 may be any one of resin, glass cement, and polymethyl methacrylate (PMMA).

In S23, a seed layer V is formed on a side of the base model 003. The seed layer V may serve as an electroforming master used in a subsequent electroforming process.

In some examples, the seed layer V may be attached to a side of the base model 003. The formation method of the seed layer will not be limited in the embodiments of the present disclosure.

In some examples, a material of the seed layer V may be copper or titanium. Based on this, the seed layer V may have a good conductivity, so as to promote the growth of metal on the seed layer V to form the reflective pillars 10. The material of the seed layer V is not limited in some of the embodiments of the present disclosure.

In S24, a metal is injected into the third hollow regions E3 by electroforming to form the reflective pillars 10; every at least three adjacent reflective pillars 10 are arranged around a second support portion F3.

In the step S24, a metal is injected into the third hollow regions E3 by electroforming until reaching the seed layer V therebelow to form the reflective pillars 10 on the seed layer V.

In some examples, the injected metal may be a metal with a high reflectivity. Based on this, the reflective pillars made of the metal may be made to have a high reflectivity, and the loss of light caused by the optical device 100 may be reduced. For example, the injected metal may be silver or nickel.

It will be understood that, every at least three adjacent reflective pillars 10 are arranged around a second support portion F3. Thus, when the optical device 100 performs aerial projection, the light provided by the external light source may pass through the second support portion F3 and illuminate onto the reflective pillar 10 adjacent to the second support portion F3, and then the light propagates in the second support portion F3 after being reflected by the reflective pillar 10, and illuminate onto another reflective pillar 10, and is emitted from the transparent support block F1, i.e., emitted from the optical device 100, after being reflected again; and then, a real image (real mirror image) is formed in the air on the side of the optical device 100 away from the external light source.

Based on this, in the step S22, a material with high transmittance is used to form the second support portion F3, which may reduce the loss of light caused by the second support portion F3 itself, so as to reduce the impact of the second support portion F3 on the transmittance of optical device 100 to ensure the brightness of the real image (real mirror image) formed by the optical device 100.

In S25, the seed layer V is removed. In some examples, the seed layer V may be removed by means of grinding to form the optical device 100. The manner of removing the seed layer V is not limited in some of the embodiments of the present disclosure.

In the manufacturing method of the optical device provided by some embodiments of the present disclosure, the base substrate 002 is patterned, so that the base substrate 002 forms a plurality of first support portions F2 and a plurality of second hollow regions E2. The plurality of first support portions F2 and the plurality of second hollow regions E2 are arranged in a checkerboard structure, so that every at least three adjacent first support portions F2 define a second hollow region E2, and then copy and demolding are performed on the patterned base substrate 002 to obtain the base model 003 having a plurality of third hollow regions E3 and a plurality of second support portions F3. The third hollow regions E3 are in one-to-one correspondence with the first support portions F2, and the second support portions F3 are in one-to-one correspondence with the second hollow regions E2. The plurality of third hollow regions E3 and the plurality of second support portions F3 are arranged in a checkerboard structure, so that every at least three adjacent third hollow regions E1 are arranged around a second support portion F3.

The base model 003 is then attached to the seed layer V, and the seed layer V is used to form a master for electroforming. The metal is injected into the third hollow regions E3 to form the reflective pillars 10. In this case, the plurality of reflective pillars 10 and the plurality of second support portions F3 are arranged in a checkerboard structure, so that every at least three adjacent reflective pillars 10 are arranged around a second support portion F3 to form the optical device 100.

In addition, in the manufacturing method of the optical device provided by some embodiments of the present disclosure, the base substrate 002 is patterned, and copy and demolding are performed on the patterned base substrate 002 to obtain the base model 003 having a plurality of third hollow regions E3 and a plurality of second support portions F3; then, the metal is injected into the base model 003 by electroforming to integrally form the plurality of reflective pillars 10. Thus, compared with the precise cutting and attaching processes, the manufacturing method has a simple process, which is conducive to mass production.

In some embodiments, referring to FIGS. 22 and 23, and as shown in FIGS. 16 and 17, in a case where the optical device 100 includes a transparent support layer 20, the transparent support layer 20 includes a plurality of transparent support portions 21. The second support portions F3 serve as the transparent support portions 21.

With such arrangement, it may be possible to not only meet the requirements for transmittance of the second support portion F3 to reduce the impact of the second support portion F3 on the light, but also meet the requirements for the hardness of the second support portion F3 to improve the stability of the optical device 100. The material of the second support portion 30 is not limited in some of the embodiments of the present disclosure.

In some other embodiments, the manufacturing method of the optical device, after step S24 and before step S25, further includes step S241 in which the second support portions F3 are removed and the reflective pillars 10 are retained to form the optical device 100.

Based on this, the second support portion F3 is removed, so that a hollow region may be formed, and the hollow region may serve as an optical channel S. Furthermore, every at least three adjacent reflective pillars 10 may be arranged around an optical channel S formed by removing the second support portion F3. Thus, the light propagates in the optical channel S, is reflected on the adjacent reflective pillar 10 in the optical channel S, and is emitted from the optical device 100 after being reflected at least twice to form a real image (real mirror image) in the air.

In some embodiments, in the manufacturing method of the optical device, in the step S25, after removing the seed layer V, the reflective pillars 10 may be encapsulated to form the optical device 100.

In some examples, an encapsulation film layer may be formed on both sides in the extending direction of the reflective pillars 10, so that the encapsulation film layer may protect the reflective pillars 10 to prevent the reflective pillars 10 from being scratched, so as to ensure the reflection effect of the reflective pillars 10.

For example, referring to FIGS. 22 and 23, and as shown in FIG. 18, in a case where the optical device 100 includes a transparent protective layer 30, the encapsulation film layer serves as the transparent protective layer 30.

The above embodiments are described by taking an example in which the base substrate includes a metal base substrate or silicon-based base substrate. The following will be described with reference to the relevant drawings by taking an example in which the base substrate is a glass base substrate.

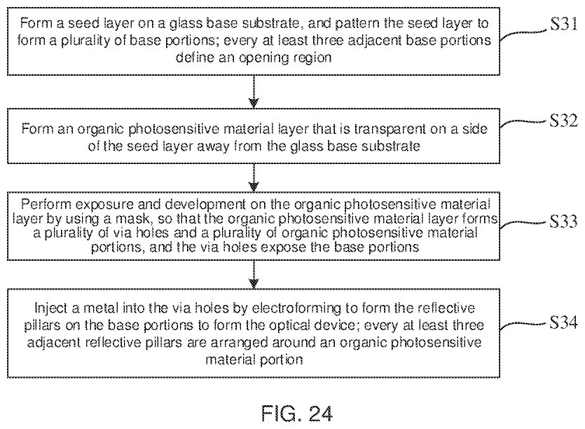

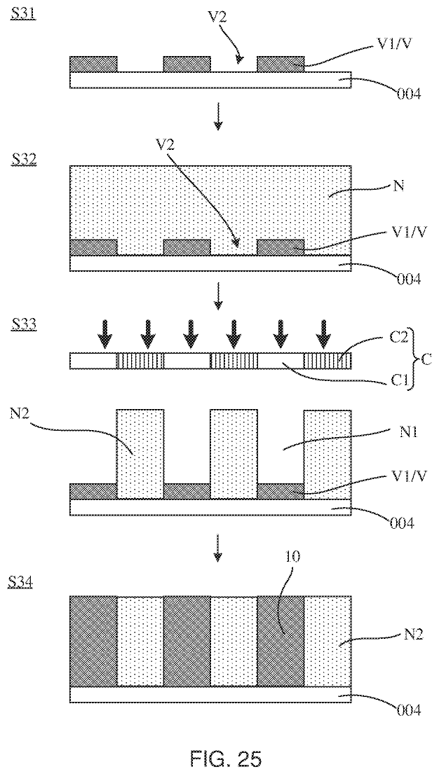

FIG. 24 is yet another flow diagram of some steps in FIG. 19, and FIG. 25 is a structural diagram of some steps in FIG. 24.

Referring to FIGS. 24 and 25, in the step S01, the base substrate may include a glass base substrate. The step S02 in which the plurality of reflective pillars are formed on the base substrate includes the following steps.

In S31, a seed layer V is formed on the glass base substrate 004, and the seed layer V is patterned to form a plurality of base portions V1; every at least three adjacent base portions V1 define an opening region V2.

The seed layer V may be used as an electroforming master used in a subsequent electroforming process.

In some examples, the seed layer V may be attached to a side of the glass base substrate 004. The formation method of the seed layer will not be limited in the embodiments of the present disclosure.

In some examples, a material of the seed layer V may be copper or titanium. Based on this, the seed layer V may have a good conductivity, so as to promote the growth of metal on the seed layer V to form the reflective pillars 10. The material of the seed layer V is not limited in some of the embodiments of the present disclosure.

In S32, an organic photosensitive material layer N that is transparent is formed on a side of the seed layer V away from the glass base substrate 004.

In some examples, a material of the organic photosensitive material layer N may be photoresist (PR).

In S33, exposure and development are performed on the organic photosensitive material layer N by using a mask C, so that the organic photosensitive material layer N forms a plurality of via holes N1 and a plurality of organic photosensitive material portions N2, and the via holes N1 expose the base portions V1.

In the step S33, the mask C includes light-transmitting regions C1 and light-blocking regions C2. Exposure and development are performed on the organic photosensitive material layer N by using the mask C, so that the organic photosensitive material layer N forms a plurality of via holes N1 and a plurality of organic photosensitive material portions N2.

In some examples, as shown in FIG. 25, considering an example in which the organic photosensitive material is a positive organic photosensitive material, an orthographic projection of a light-blocking region C2 on the glass base substrate 004 substantially coincides with an orthographic projection of an organic photosensitive material portion N2 on the glass base substrate 004; an orthographic projection of a light-transmitting region C1 on the glass base substrate 004 substantially coincides with an orthogonal projection of a via hole N1 on the glass base substrate 004.

It will be understood that in some other examples, the organic photosensitive material may be a negative organic photosensitive material; an orthographic projection of a light-transmitting region on the glass base substrate substantially coincides with an orthogonal projection of an organic photosensitive material portion on the glass base substrate; an orthographic projection of a light-blocking region on the glass base substrate substantially coincides with an orthogonal projection of a via hole on the glass base substrate.

In some examples, in the step S33, the orthographic projection of the light-transmitting region C1 on the glass base substrate 004 may be set to substantially coincide with the orthographic projection of the base portion V1 on the glass base substrate 004, so that the formed via hole N1 may expose the base portion V1.

It will be noted that “substantially coincidence” includes absolute coincidence and approximate coincidence. That is, the fluctuation of the difference between an edge of the orthographic projection of the light-transmitting region C1 on the glass base substrate 004 and an edge of the orthographic projection of the base portion V1 on the glass base substrate 004 does not exceed an error threshold, which may also be considered that the orthographic projection of the light-transmitting region C1 on the glass base substrate 004 substantially coincides with the orthographic projection of the base portion V1 on the glass base substrate 004. The specific value of the error threshold is not limited in the present disclosure.

In S34, a metal is injected into the via holes N1 by electroforming to form the reflective pillars 10 on the base portions V1 to form the optical device 100; every at least three adjacent reflective pillars 10 are arranged around an organic photosensitive material portion N2.

In the manufacturing method of the optical device provided in some embodiments of the present disclosure, the seed layer V on the glass base substrate 004 is patterned to form the base portions V1 for growing the reflective pillars 10 in a subsequent process; every at least three adjacent base portions V1 define an opening region V2; the patterned seed layer V is coated with an organic photosensitive material layer N; exposure and development are performed on the organic photosensitive material layer N by using a mask C, so that the organic photosensitive material layer N forms a plurality of via holes N1 to expose the base portions V1; and subsequently, the metal is injected into the via holes N1 to form the reflective pillars 10. In this case, the plurality of reflective pillars 10 and the plurality of organic photosensitive material portions N2 are arranged in a checkerboard structure, so that every at least three adjacent reflective pillars 10 are arranged around an organic photosensitive material portion N2 to form the optical device 100.

In the formed optical device 100, the organic photosensitive material layer N is made of a material with high transmittance. Every at least three adjacent reflective pillars 10 are arranged around an organic photosensitive material portion N2, and thus, when the optical device 100 performs aerial projection, the light provided by the external light source may illuminate onto the organic photosensitive material portion N2, and illuminate onto the reflective pillar 10 adjacent to the organic photosensitive material portion N2; the light propagates in the organic photosensitive material portion N2 after being reflected by the reflective pillar 10, and illuminate onto another reflective pillar 10, and is emitted from the organic photosensitive material portion N2, i.e., emitted from the optical device 100, after being reflected again; and then, a real image (real mirror image) is formed in the air on the side of the optical device 100 away from the external light source. Using the organic photosensitive material layer N that is transparent may prevent the organic photosensitive material layer N from affecting the transmittance of light, thereby reducing the imaging effect of the optical device 100.

In addition, in the manufacturing method of the optical device provided by the embodiments of the present disclosure, the seed layer V is patterned, the organic photosensitive material layer N is used to expose the base portions V1, and the metal is injected into the base portions V1 by electroforming, so that the plurality of reflective pillars 10 are integrally formed. Thus, compared with the precise cutting and attaching processes, the manufacturing method has a simple process, which is conducive to mass production.

In some embodiments, referring to FIGS. 24 and 25, and as shown in FIGS. 16 and 17, a transmittance of the organic photosensitive material layer N is greater than or equal to 95%. Furthermore, the transmittance of the organic photosensitive material portion N2 formed in the organic photosensitive material layer N is greater than or equal to 95%. The organic photosensitive material portion N2 is set to have a high transmittance, which may help reduce the light loss caused by the organic photosensitive material portion N2 to light.

In some examples, in a case where the optical device 100 includes a transparent support layer 20, the transparent support layer 20 includes a plurality of transparent support portions 21. The organic photosensitive material portions N2 may serve as the transparent support portions 21.

In some other embodiments, the manufacturing method of the optical device, after step S34, further includes step S35 in which the organic photosensitive material portions N2 are removed and the reflective pillars 10 are retained to form the optical device 100.

Based on this, the organic photosensitive material portion N2 is removed to form a hollow region, and the hollow region may serve as the optical channel S. Furthermore, every at least three adjacent reflective pillars 10 may be arranged around an optical channel S formed by removing the organic photosensitive material portion N2. Thus, the light propagates in the optical channel S, is reflected on the adjacent reflective pillar 10 in the optical channel S, and is emitted from the optical device 100 after being reflected twice to form a real image (real mirror image) in the air.

In some other embodiments, in a case where the transmittance of the organic photosensitive material layer N used in the manufacturing method of the optical device is low, the manufacturing method, after the step S35, further includes step S36 in which the organic photosensitive material portion N2 is removed to form an optical channel, and the optical channel is filled with a transparent support portion 21; the transmittance of the transparent support portion 21 is greater than or equal to 95%. With such arrangement, the organic photosensitive material layer N with low transmittance is removed and replaced with the transparent support portion 21 with high transmittance, which may reduce the light loss caused by the transparent support portion 21 to the light.

In some examples, a material of the transparent support portion 21 includes any one of resin, glass cement, and polymethyl methacrylate (PMMA).

The transparent support portion 21 is made of any one of resin, glass cement, and polymethyl methacrylate (PMMA), so that the transparent support portion 21 has a high transmittance and a high hardness. Thus, it may be possible to not only meet the requirement for the transmittance of the transparent support portion 21 to reduce the impact on the light in the optical channel S, but also meet the requirement for the hardness of the transparent support portion 21 to improve the stability of the optical device 100. Moreover, the material of the transparent support portion 21 is not limited in some of the embodiments of the present disclosure.

The above are only specific embodiments of the present disclosure, but the scope of protection of the present disclosure is not limited thereto, and any person skilled in the art may conceive of variations or replacements within the technical scope of the present disclosure, which shall fall within the protection scope of the present disclosure. Therefore, the protection scope of the present disclosure should be determined by the protection scope of the claims.

1. An optical device, comprising a plurality of reflective pillars extending in a first direction, wherein the plurality of reflective pillars are arranged in a plurality of rows and a plurality of columns; the first direction is perpendicular to both a row direction and a column direction; wherein
every at least three adjacent reflective pillars define an optical channel extending in the first direction; each optical channel includes a plurality of reflective surfaces arranged in a circumferential direction of the optical channel, and the plurality of reflective surfaces include two reflective surfaces that are adjacent and perpendicular to each other, wherein a plurality of reflective surfaces defining the optical channel are respectively located on different reflective pillars.

2. The optical device according to claim 1, wherein in the reflective pillars defining the optical channel, side edges of every two adjacent reflective pillars are connected to each other.

3. The optical device according to claim 1, wherein the optical channel is defined by 4 adjacent reflective pillars, the optical channel includes 4 reflective surfaces arranged in the circumferential direction of the optical channel, and an included angle between planes where every two adjacent reflective surfaces are located is a right angle.

4. The optical device according to claim 1, wherein widths of the reflective surfaces defining the optical channel are equal; and/or
a reflective pillar in the plurality of reflective pillars is in a shape of a quadrangular prism.

5. (canceled)

6. The optical device according to claim 1, wherein a depth-to-width ratio of a reflective pillar in the plurality of reflective pillars is in a range of 1:1 to 3:1, inclusive.

7. The optical device according to claim 1, wherein a depth of a reflective pillar in the plurality of reflective pillars in the first direction is in a range of 100 μm to 600 μm, inclusive.

8. The optical device according to claim 7, wherein the depth of the reflective pillar in the first direction is approximately 150 μm, and a depth-to-width ratio of the reflective pillar is approximately 2.67.

9. The optical device according to claim 8, wherein there are a plurality of optical channels; spatial uniformity of multiple rays of light reflected by the plurality of optical channels is in a range of 100 to 250, inclusive.

10. The optical device according to claim 1, wherein a surface roughness of a reflective surface is less than or equal to 0.8 μm; and/or
a material of a reflective pillar in the plurality of reflective pillars includes any one of silver, aluminium and nickel.

11. (canceled)

12. The optical device according to claim 1, further comprising a transparent support layer, wherein the transparent support layer includes a plurality of transparent support portions, a transparent support portion is located between adjacent reflective pillars, and fills an optical channel.

13. The optical device according to claim 12, wherein a material of the transparent support layer includes any one of resin, glass cement, and polymethyl methacrylate.

14. The optical device according to claim 1, wherein a reflective pillar in the plurality of reflective pillars includes a first surface and a second surface that are arranged oppositely in the first direction;
the optical device further comprises a transparent protective layer; wherein
the transparent protective layer includes a first transparent protective layer located on a side of first surfaces of the plurality of reflective pillars away from second surfaces of the plurality of reflective pillars; and/or
the transparent protective layer includes a second transparent protective layer located on a side of the second surfaces of the plurality of reflective pillars away from the first surfaces of the plurality of reflective pillars.

15. The optical device according to claim 14, further comprising a transparent support layer, wherein the transparent support layer includes a plurality of transparent support portions, a transparent support portion is located between adjacent reflective pillars and fills an optical channel, and a refractive index of the transparent protective layer is substantially equal to a refractive index of the transparent support layer.

16. The optical device according to claim 14, wherein a material of the transparent protective layer includes inorganic glass or organic glass.

17. A display assembly, comprising a display apparatus and the optical device according to claim 1, wherein a first included angle is formed between the display apparatus and the optical device, and the first included angle is in a range of 30° to 60°, inclusive.

18. A head-up display system, comprising the display assembly according to claim 17.

19. A manufacturing method of an optical device, wherein the optical device includes a plurality of reflective pillars extending in a first direction, and the plurality of reflective pillars are arranged in a plurality of rows and a plurality of columns; the first direction is perpendicular to both a row direction and a column direction; wherein
every at least three adjacent reflective pillars define an optical channel extending in the first direction; each optical channel includes a plurality of reflective surfaces arranged in a circumferential direction of the optical channel, and the plurality of reflective surfaces include two reflective surfaces that are adjacent and perpendicular to each other, wherein a plurality of reflective surfaces defining the optical channel are respectively located on different reflective pillars;
the manufacturing method comprises:
providing a base substrates; and
forming the plurality of reflective pillars on the base substrate to form the optical device.

20. The manufacturing method according to claim 19, wherein
the base substrate includes a transparent base substrate;
forming the plurality of reflective pillars on the base substrate includes:
performing a burning process on the transparent base substrate to form a plurality of first hollow regions and a plurality of transparent support blocks, every adjacent at least three first hollow regions being arranged around a transparent support block;
forming a seed layer on a side of the transparent base substrate;
injecting a metal into the plurality of first hollow regions by electroforming to form the plurality of reflective pillars, every at least three adjacent reflective pillars being arranged around a transparent support block; and
removing the seed layer.

21. The manufacturing method according to claim 19, wherein
the base substrate includes a metal base substrate or a silicon-based base substrate;
forming the plurality of reflective pillars on the base substrate includes:
patterning the base substrate to form a plurality of first support portions, every at least three adjacent first support portions defining a second hollow region;
performing copy and demolding on the base substrate by press molding to form a base model having a plurality of third hollow regions and a plurality of second support portions that are transparent, every at least three adjacent third hollow regions being arranged around a second support portion;
forming a seed layer on a side of the base model;
injecting a metal into the plurality of third hollow regions by electroforming to form the plurality of reflective pillars, every at least three adjacent reflective pillars being arranged around a second support portion; and
removing the seed layer.

22. The manufacturing method according to claim 19, wherein
the base substrate includes a glass base substrate;
forming the plurality of reflective pillars on the base substrate includes:
forming a seed layer on the glass base substrate;
patterning the seed layer to form a plurality of base portions, every at least three adjacent base portions defining an opening region;
forming an organic photosensitive material layer that is transparent on a side of the seed layer away from the glass base substrate;
performing exposure and development on the organic photosensitive material layer by using a mask, so that the organic photosensitive material layer forms a plurality of via holes and a plurality of organic photosensitive material portions, and the via holes expose the base portions; and
injecting a metal into the via holes by electroforming to form the reflective pillars on the base portions, so as to form the optical device, wherein every at least three adjacent reflective pillars are arranged around an organic photosensitive material portion.
